(19) United States
(12) Patent Application Publication
(10) Pub. No.: US 2022/0193606 A1
(43) Pub. Date: Jun. 23, 2022

(54) CAPTURING CARBON DIOXIDE

(71) Applicant: Carbon Engineering Ltd., Squamish (CA)

(72) Inventors: Kevin Nold, Squamish (CA); Briac Medard De Chardon, Vancouver (CA); Stephen Slen, Squamish (CA); Douglas Edward Olmstead, Squamish (CA); Teerawat Sanpasertparnich, North Vancouver (CA); Megan Lynn O'Brien, Squamish (CA); Geoff Holmes, Squamish (CA); David St. Angelo, Squamish (CA); Kim Martin Nikolaisen, British Columbia (CA); Trevor Sean Follett, West Vancouver (CA); Benjamin Ignace Lafferty, Edmonton (CA)

(21) Appl. No.: 17/558,321

(22) Filed: Dec. 21, 2021

Related U.S. Application Data
(60) Provisional application No. 63/128,384, filed on Dec. 21, 2020.

(51) Int. Cl. B01D 53/78; B01D 53/14; B01D 53/18; B01J 4/00

(52) U.S. Cl. CPC B01D 53/78; B01D 53/1475; B01D 2259/124; B01J 4/002; B01D 2257/504; B01D 53/185

(57) ABSTRACT

A system for capturing CO₂ from a dilute gas source includes a gas-liquid contactor including a housing coupled to a plurality of structural members; one or more basins positioned within the housing and configured to hold a CO₂ capture solution, the one or more basins including a bottom basin; one or more packing sections positioned at least partially above the bottom basin; a fan operable to circulate a CO₂-laden gas through the one or more packing sections; and a liquid distribution system configured to flow the CO₂ capture solution onto the one or more packing sections.

### CROSS-REFERENCE TO RELATED APPLICATION

This application claims priority under 35 U.S.C. § 119 to U.S. Provisional Patent Application Ser. No. 63/128,384, filed on Dec. 21, 2020, the entire contents of which are incorporated by reference herein.

### TECHNICAL FIELD

This disclosure describes systems, apparatus, and methods for capturing carbon dioxide.

### BACKGROUND

Capturing carbon dioxide (CO₂) from the atmosphere is one approach to mitigating greenhouse gas emissions and slowing climate change. However, many technologies designed for CO₂ capture from point sources, such as flue gas of industrial facilities, are generally ineffective in capturing CO₂ from the atmosphere due to the significantly lower CO₂ concentrations and large volumes of air required to process. In recent years, progress has been made in finding technologies better suited to capture CO₂ directly from the atmosphere. Some of these direct air capture (DAC) systems use a solid sorbent where an active agent is attached to a substrate. These DAC systems typically employ a cyclic adsorption-desorption process where, after the solid sorbent is saturated with CO₂, it releases the CO₂ using a humidity or thermal swing and is regenerated.

Other DAC systems use a liquid sorbent (sometimes referred to as a solvent) to capture CO₂ from the atmosphere. An example of such a gas-liquid contact system would be one that is based on cooling tower designs where a fan is used to draw air across a high surface area packing that is wetted with a solution comprising the liquid sorbent. CO₂ in the air reacts with the liquid sorbent. The rich solution is further processed downstream to regenerate a lean solution and to release a concentrated carbon stream, for example, CO, CO₂ or other carbon products. DAC systems that are designed based on cooling towers are advantageous since they employ some commercially available equipment and they can move large amounts of air. It is desirable for DAC systems to be simply maintainable and operationally flexible.

### SUMMARY

In an example implementation, a system for capturing CO₂ from a dilute gas source includes a gas-liquid contactor including a housing coupled to a plurality of structural members; one or more basins positioned within the housing and configured to hold a CO₂ capture solution, the one or more basins including a bottom basin; one or more packing sections positioned at least partially above the bottom basin; a fan operable to circulate a CO₂-laden gas through the one or more packing sections; and a liquid distribution system configured to flow the CO₂ capture solution onto the one or more packing sections.

In an aspect combinable with the example implementation, the gas-liquid contactor includes one or more materials of construction (MOCs) that are compatible with the CO₂ capture solution.

In another aspect combinable with any of the previous aspects, the one or more MOCs include at least one of: fiber reinforced plastic (FRP) or stainless steel.

In another aspect combinable with any of the previous aspects, the FRP includes vinyl ester and fiberglass.

In another aspect combinable with any of the previous aspects, the housing includes one or more openings and one or more cut ends.

In another aspect combinable with any of the previous aspects, the one or more openings and one or more cut ends are lined with a sealant layer.

In another aspect combinable with any of the previous aspects, the sealant layer includes vinyl ester resin.

In another aspect combinable with any of the previous aspects, the one or more openings are lined with a protective sleeve.

In another aspect combinable with any of the previous aspects, the protective sleeve includes PVC.

In another aspect combinable with any of the previous aspects, a protective coating applied to at least one of: the plurality of structural members, the housing, or the one or more basins.

In another aspect combinable with any of the previous aspects, the protective coating includes at least one of: vinyl ester, polyurethane, stainless steel, or epoxy.

In another aspect combinable with any of the previous aspects, the protective coating includes an additive.

In another aspect combinable with any of the previous aspects, the bottom basin includes at least one of: an HDPE basin section or a concrete basin section.

In another aspect combinable with any of the previous aspects, the HDPE basin section is coupled to a basin support structure.

In another aspect combinable with any of the previous aspects, the concrete basin section embeds a waterstop including at least one of: thermoplastic vulcanizate (TPV), PVC, hydrophilic chloroprene rubber, or stainless steel.

In another aspect combinable with any of the previous aspects, a geomembrane liner surrounds at least a portion of the bottom basin, the geomembrane liner including at least one of: HDPE or ethylene propylene diene monomer (EPDM).

In another aspect combinable with any of the previous aspects, a leak detection system intervenes the bottom basin and the geomembrane liner.

In another aspect combinable with any of the previous aspects, the geomembrane liner is held against the concrete basin section by a pinch bar.

In another aspect combinable with any of the previous aspects, the plurality of structural members define a plenum including a containment.

In another aspect combinable with any of the previous aspects, the containment is at least partially segregated from the bottom basin.

In another aspect combinable with any of the previous aspects, the containment is at least partially separated from the bottom basin by one or more walls, the bottom basin positioned at least partially below the packing.

In another aspect combinable with any of the previous aspects, the one or more walls include at least one of: concrete or stainless steel.

In another aspect combinable with any of the previous aspects, the containment includes a sump fluidly coupled to a drain pipe that is operable to flow a volume of liquid outside of the containment.

In another aspect combinable with any of the previous aspects, the containment includes a sump pump positioned within a sump, the sump pump operable to flow a volume of liquid to the bottom basin.

In another aspect combinable with any of the previous aspects, the volume of liquid includes a volume of water and a portion of the CO₂ capture solution.

In another aspect combinable with any of the previous aspects, the plenum includes a plenum containment floor fitted with a drainage slope of at least 2%.

In another aspect combinable with any of the previous aspects, the plurality of structural members is mounted above a liquid level in the bottom basin.

In another aspect combinable with any of the previous aspects, the plurality of structural members is mounted on one or more walls bordering the bottom basin.

In another aspect combinable with any of the previous aspects, the one or more walls include one or more raised walls that extend above the liquid level of the bottom basin.

In another aspect combinable with any of the previous aspects, a protective coating applied to at least one of: the one or more walls or the one or more raised walls.

In another aspect combinable with any of the previous aspects, the liquid distribution system includes one or more liquid distribution pipes each having a set of sparger holes; and a set of nozzles positioned below the one or more liquid distribution pipes.

In another aspect combinable with any of the previous aspects, the one or more basins includes a top basin; and the set of sparger holes is oriented at least partially towards a bottom surface of the top basin.

In another aspect combinable with any of the previous aspects, a weir coupled to the bottom surface of the top basin, the weir configured to form a first reservoir and a second reservoir of the CO₂ capture solution in the top basin, wherein the CO₂ capture solution flows from the first reservoir to the second reservoir.

In another aspect combinable with any of the previous aspects, the set of sparger holes are at least partially submerged in the first reservoir in the top basin.

In another aspect combinable with any of the previous aspects, the set of nozzles are fluidly coupled with the second reservoir in the top basin.

In another aspect combinable with any of the previous aspects, the one or more packing sections includes a first packing section positioned at least partially above a second packing section.

In another aspect combinable with any of the previous aspects, at least one packing support intervenes the first packing section and the second packing section of the one or more packing sections.

In another aspect combinable with any of the previous aspects, the first packing section includes a first flute angle and the second packing section includes a second flute angle that is different from the first flute angle.

In another aspect combinable with any of the previous aspects, the one or more packing sections includes a set of cross-corrugated packing sheets.

In another aspect combinable with any of the previous aspects, the one or more packing sections include substantially no gaps.

In another aspect combinable with any of the previous aspects, the one or more packing sections is a monolithic packing block.

In another aspect combinable with any of the previous aspects, the monolithic packing block is supported by at least one packing support.

In another aspect combinable with any of the previous aspects, a liquid redistributor positioned in between the one or more sections of packing.

In another aspect combinable with any of the previous aspects, the liquid redistributor includes the second packing section of the one or more packing sections.

In another aspect combinable with any of the previous aspects, the liquid redistributor includes one or more redistribution nozzles configured to flow the CO₂ capture solution to the second packing section.

In another aspect combinable with any of the previous aspects, a fan stack partially enclosing the fan.

In another aspect combinable with any of the previous aspects, the fan stack includes a fan stack height that is between 10 ft. and 30 ft., between 10 ft. and 20 ft., or between 20 ft. and 30 ft.

In another aspect combinable with any of the previous aspects, the fan is configured to discharge a CO₂-lean gas at an exhaust velocity ranging from 9 m/s to 15 m/s.

In another aspect combinable with any of the previous aspects, the fan includes a fan diameter that is between 10 ft. and 30 ft., between 10 ft. and 15 ft., or between 15 ft. and 30 ft.

In another aspect combinable with any of the previous aspects, the set of slatted louvers positioned upstream of the one or more packing sections, the set of slatted louvers oriented to block at least a portion of the CO₂ capture solution.

In another aspect combinable with any of the previous aspects, the set of slatted louvers is positioned upstream of a set of structured louvers.

In another example implementation, a method for removing carbon dioxide from a dilute gas mixture, the method includes flowing a CO₂-laden gas into a gas-liquid contactor by operating a fan, the gas-liquid contactor including: a housing including a plurality of structural members, one or more packing sections, one or more basins, and a fan stack partially surrounding the fan; flowing a CO₂ capture solution over the one or more packing sections; and absorbing at least a portion of CO₂ from the CO₂-laden gas with the CO₂ capture solution to yield a CO₂-lean gas.

In another aspect combinable with any of the previous aspects, the CO₂-laden gas includes atmospheric air.

In another aspect combinable with any of the previous aspects, receiving a volume of liquid into a containment, wherein the containment is positioned within a plenum defined by the plurality of structural members and at least a portion of the containment is segregated from the one or more basins.

In another aspect combinable with any of the previous aspects, receiving the volume of liquid into the containment includes receiving rainwater through the fan stack of the gas-liquid contactor.

In another aspect combinable with any of the previous aspects, receiving the liquid into the containment includes receiving a portion of the CO₂ capture solution from the one or more packing sections of the gas-liquid contactor.

In another aspect combinable with any of the previous aspects, segregating at least a portion of the containment from the one or more basins.

In another aspect combinable with any of the previous aspects, segregating at least a portion of the containment from the one or more basins includes segregating at least a portion of the containment from the one or more basins by one or more raised walls.

In another aspect combinable with any of the previous aspects, the one or more raised walls include at least one of: stainless steel or concrete.

In another aspect combinable with any of the previous aspects, raising at least a portion of the plurality of structural members above a liquid level in the one or more basins by supporting the plurality of structural members on the one or more raised walls.

In another aspect combinable with any of the previous aspects, draining the volume of liquid from the containment.

In another aspect combinable with any of the previous aspects, draining the volume of liquid from the containment includes flowing the volume of liquid into a sump and a drain pipe; and flowing the volume of liquid outside of the containment.

In another aspect combinable with any of the previous aspects, draining the volume of liquid from the containment includes flowing the volume of liquid into a sump including a sump pump; and operating the sump pump to flow the volume of liquid to the bottom basin.

In another aspect combinable with any of the previous aspects, draining the volume of liquid from the containment includes flowing the volume of liquid on a plenum floor fitted with a drainage slope of at least 2%.

In another aspect combinable with any of the previous aspects, the volume of liquid includes a volume of water and a portion of the CO₂ capture solution.

In another aspect combinable with any of the previous aspects, flowing the CO₂-laden gas through a set of slatted louvers.

In another aspect combinable with any of the previous aspects, flowing the CO₂-laden gas through a set of structured louvers downstream of the set of slatted louvers.

In another aspect combinable with any of the previous aspects, including flowing the CO₂ capture solution into a distribution pipe; flowing the CO₂ capture solution through a set of sparger holes in the distribution pipe into a top basin of the one or more basins; and flowing the CO₂ capture solution through a set of nozzles in the top basin to at least a portion of the one or more packing sections.

In another aspect combinable with any of the previous aspects, the set of sparger holes are oriented at least partially towards a bottom surface of the top basin.

In another aspect combinable with any of the previous aspects, flowing the liquid over a weir coupled to the bottom surface of the top basin, the weir forming a first reservoir and a second reservoir in the top basin, wherein the CO₂ capture solution flows from the first reservoir to the second reservoir.

In another aspect combinable with any of the previous aspects, flowing the CO₂ capture solution through the set of sparger holes includes flowing the CO₂ capture solution through the set of sparger holes submerged in the first reservoir.

In another aspect combinable with any of the previous aspects, flowing the CO₂ capture solution through the set of nozzles includes flowing the CO₂ capture solution from the second reservoir in the top basin.

In another aspect combinable with any of the previous aspects, the CO₂-laden gas includes atmospheric air.

In another aspect combinable with any of the previous aspects, flowing the CO₂ capture solution through the set of nozzles in the top basin includes flowing the CO₂ capture solution through the set of nozzles at a flow rate of less than 14 gpm/ft².

In another aspect combinable with any of the previous aspects, the one or more packing sections includes a set of cross-corrugated packing sheets.

In another aspect combinable with any of the previous aspects, the one or more packing sections is a monolithic packing block.

In another aspect combinable with any of the previous aspects, flowing the CO₂ capture solution through a liquid redistributor positioned at least partially below a first packing section of the one or more packing sections.

In another aspect combinable with any of the previous aspects, flowing the CO₂ capture solution through the liquid redistributor includes flowing the CO₂ capture solution through a set of collection troughs and a set of redistribution nozzles.

In another aspect combinable with any of the previous aspects, flowing the CO₂ capture solution from the set of redistribution nozzles to a counterflow film packing positioned below the redistribution nozzles.

In another aspect combinable with any of the previous aspects, flowing the CO₂ capture solution through a first packing section having a first flute angle and flowing the CO₂ capture solution through a liquid redistributor including a second packing section having a second flute angle that is different from the first flute angle.

In another aspect combinable with any of the previous aspects, flowing the CO₂ capture solution through the liquid redistributor includes flowing the CO₂ capture solution through a counterflow film packing.

In another aspect combinable with any of the previous aspects, flowing the CO₂ capture solution through the liquid redistributor includes flowing the CO₂ capture solution through a pressurized distribution pipe and a set of redistribution nozzles.

In another aspect combinable with any of the previous aspects, operating a fan includes operating the fan to discharge the CO₂-lean gas from the fan stack at an exhaust velocity of at least 9 m/s to 15 m/s.

In another aspect combinable with any of the previous aspects, the fan includes a fan diameter that is between 10 ft. and 30 ft., between 10 ft. and 15 ft., or between 15 ft. and 30 ft.

In another aspect combinable with any of the previous aspects, the fan stack includes a fan stack height that is between 10 ft. and 30 ft., between 10 ft. and 20 ft., or between 20 ft. and 30 ft.

In another example implementation, a system for contacting a gas with a liquid includes a housing coupled to a plurality of structural members; one or more basins positioned within the housing and configured to hold a liquid, the one or more basins including a bottom basin and a top basin; one or more packing sections positioned at least partially above the bottom basin, the one or more packing sections including substantially no gaps; a fan operable to circulate a gas through the one or more packing sections; and a liquid distribution system configured to flow the liquid onto the one or more packing sections, the liquid distribution system including a set of nozzles and one or more liquid distribution pipes each having a set of sparger holes, wherein the set of nozzles is positioned below the one or more liquid distribution pipes.

In another aspect combinable with any of the previous aspects, a weir coupled to a bottom surface of the top basin, the weir configured to form a first reservoir and a second reservoir of the liquid in the top basin, wherein the liquid flows from the first reservoir to the second reservoir; the set of sparger holes are at least partially submerged in the first reservoir; and the set of nozzles is fluidly coupled with the second reservoir.

In another aspect combinable with any of the previous aspects, a liquid redistributor positioned in between the one or more packing sections, wherein the one or more packing sections includes a first packing section and a second packing section, and the liquid redistributor includes at least one of: the second packing section or a plurality of redistribution nozzles configured to flow the liquid to the second packing section.

In another aspect combinable with any of the previous aspects, a set of baffles positioned adjacent to at least one of the one or more packing sections or a liquid redistributor.

Implementations of systems and methods for capturing carbon dioxide according to the present disclosure may include one, some, or all of the following features. For example, gas-liquid contactor with features described in this invention are designed specifically for commercial DAC applications and as such can improve overall CO₂ capture efficiency of the DAC process. Design criteria of a gas-liquid contactor that reflect good performance include: reduced air bypass, reduced pressure drop across the packing, preventing plume re-ingestion, ability to distribute CO₂ capture solution evenly throughout the packing and minimizing contamination of the capture solution. Improving reliability of the contactor through application of materials of construction (MOC) described in this application can provide for a longer life of the gas-liquid contactor and reduce maintenance costs.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-1B show example gas-liquid contactors according to the present disclosure.

FIGS. 2A-2C show an example dual-cell crossflow gas-liquid contactor according to the present disclosure.

FIG. 3A shows a cross-sectional view of an example I-beam FRP structure for a gas-liquid contactor system according to the present disclosure.

FIG. 3B shows a cross-sectional view of an example U-beam FRP structure for a gas-liquid contactor system according to the present disclosure.

FIG. 3C shows a perspective view of an example beam connector FRP structure for a gas-liquid contactor system according to the present disclosure.

FIG. 4A shows a perspective view of an example portion of a gas-liquid contactor system, including a bottom basin bordered by raised walls according to the present disclosure.

FIG. 4B shows a top view of an example portion of a gas-liquid contactor system, including a bottom basin bordered by raised walls according to the present disclosure.

FIG. 5A shows a cross-sectional view of an example bottom basin containment system for a gas-liquid contactor system according to the present disclosure.

FIG. 5B shows a perspective view of an example bottom basin containment system for a gas-liquid contactor system according to the present disclosure.

FIG. 6A shows a cross-sectional view of an example distribution system including spargers and nozzles for a gas-liquid contactor system according to the present disclosure.

FIG. 6B shows a top view of an example distribution system including spargers and nozzles for a gas-liquid contactor system according to the present disclosure.

FIG. 6C shows a side cross sectional view of an example liquid distribution system that includes a weir according to the present disclosure.

FIG. 7 shows a cross-sectional view of example packing supports and baffles for a gas-liquid contactor system according to the present disclosure.

FIG. 8 shows a cross-sectional view of example structures that support structural members and a housing of a gas-liquid contactor according to the present disclosure.

FIG. 9 shows an image of example plume distributions for CO₂-lean gas discharged from different fan and fan stack designs according to the present disclosure.

FIG. 10 is a schematic diagram of an example control system for a gas-liquid contactor system according to the present disclosure.

### DETAILED DESCRIPTION

The present disclosure describes systems and method for capturing CO₂ from a dilute source, such as atmospheric air, ambient air, or other fluid sources that comprise CO₂ (referred to herein as “CO₂-laden gas”). In some aspects, a gas-liquid contactor employs a CO₂ capture solution to harvest CO₂ from CO₂-laden gas by absorption, yielding a CO₂-lean gas. In some aspects, the CO₂ capture solution can include a high pH (pH>10) solution or a caustic component (e.g., potassium hydroxide KOH or sodium hydroxide NaOH) that is capable of degrading some materials used in conventional cooling towers. In some aspects, the gas-liquid contactor includes one or more materials of construction (MOCs) that are compatible with a caustic CO₂ capture solution. Caustic-compatible MOCs will resist degradation caused by caustic materials. In some aspects, the gas-liquid contactor can include features that help prevent re-ingestion of CO₂-lean gas that is discharged from the gas-contactor. In some aspects, the gas-liquid contactor includes features that help prevent contamination of the CO₂ capture solution from rainwater. In some aspects, the gas-liquid contactor includes features that distribute CO₂ capture solution over packing or re-distribute at one or more sections within the packing to achieve a higher wetted surface area.

The present systems and methods are designed for capturing CO₂ from dilute gas sources (e.g., atmospheric or ambient air) rather than capturing CO₂ from point sources (e.g., flue gas). Such design considerations are numerous. Packed towers in chemical processing plants employ packing that is designed for CO₂ concentrations of approximately 10-15% v/v. Thus, a significantly smaller volume of gas is needed for processing in packed towers in order to capture the equivalent amount of CO₂ from the air using DAC. The higher concentrations in conventional chemical processing packed towers promotes significantly greater driving force for mass transfer and reaction kinetics in comparison to dilute concentrations. Packed towers are typically used in a counterflow configuration. A counterflow packed column for chemical processing can encounter certain problems, for example flooding. Flooding is a phenomenon by which gas moving in one direction in the packed column entrains liquid moving in the opposite direction in the packed column. Flooding is undesirable because it can cause a large pressure drop across the packed column as well as other effects that are detrimental to the performance and stability of the absorption process. The diameter to L/G velocity ratios in a chemical process counter-current flow absorber column are not the same as in a counter-current flow air contactor, hence the counter-current flow configuration in an air contactor does not run into the same issues as a chemical scrubbing tower. As such, while gas-liquid contactor systems for DAC work particularly well with a crossflow configuration due to reduced pressure drop and mitigation of gas flow restrictions, counterflow designs are also possible for gas-liquid contactors in DAC. The capture kinetics in a chemical processing facility are generally more favorable in comparison with a gas-liquid contactor designed for DAC. In some DAC gas-liquid contactor cases, pressure drops in crossflow configurations are lower than that in counterflow configurations, which can reduce operating costs of the fan. Therefore, while both point source capture and DAC technologies capture CO₂ from a gas stream, the process designs for each technology are different owing to different feedstocks, chemical reactions, and operating conditions.

Gas-liquid contactors for DAC also have numerous design considerations that are different from conventional cooling towers. For example, commercially available packing from the cooling tower industry is designed for use with water and for maximizing heat transfer with less consideration for mass transfer, which is important for a DAC system. In cooling towers, the structural framework supports the packing that is stacked or hung within the fill space of cooling tower cell.

Two types of structured packing include: splash-type fill and film type fill. Splash-type fill consists of splash bars that are typically spaced evenly and are positioned horizontally. The splash bars break the flow of liquid, resulting in the liquid cascading through spaces between the splash bars and onto other splash bars, thereby creating droplets and wetted surfaces that interface with gas.

Film-type fill is designed to promote spreading of liquid into a thin film on the surfaces of the fill. This enables maximum exposure of liquid to gas. Comparing splash-type fill to film-type fill, film-type fills are generally more compatible with DAC since they have the capacity for more effective mass transfer per unit volume of fill space. This is due in part to film-type fill having a much higher specific surface area-to-volume ratio (“specific surface area” in m²/m³) than splash-type fill. A high specific surface area is not only important for exposure of CO₂ to the surface of the capture solution, but it also has cost and structural implications. The lower the specific surface area, the more packing is required to absorb a given amount of CO₂ from the air. More packing leads to an increase in the complexity and size of structural framework required to hold the packing.

Given that the goal of DAC is mass transfer and CO₂ concentrations in air are dilute, large volumes of air must be processed by a gas-liquid contactor of a DAC system to capture meaningful quantities of CO₂. Generally, more packing is required for DAC applications than in a cooling tower, for the same density of packing. The packing air travel depth (e.g., packing depth) in a gas-liquid contactor can be in the range of 2-10 meters for DAC, which is greater than the packing depth of a just a few feet typically used in cooling towers.

Depending on the size of the gas-liquid contactor, CO₂ capture solution distribution can be an issue in tall packing structures. In some aspects, the gas-liquid contactor includes a packing of approximately the same height as the housing. While cooling towers may consist of some amount of packing to enhance heat transfer from the water to air, it is significantly less than the amount required in DAC applications. For instance, a maximum height of commercially available packings for cooling tower applications, such as Brentwood XF125, XF12560 is approximately 12 feet. The gas-liquid contactor, in some aspects, uses packing of height of at least 1.5 times the manufactured size.

In some cases, a gas-liquid contactor of a DAC system employs intermittent wetting and liquid flows that are substantially lower than that of a cooling tower. A few advantages of low liquid flows are that pumping equipment, infrastructure as well as pumping and fan power requirements are reduced. However, packing that comes from the cooling tower industry is designed for substantially higher liquid loading rates than what is used in DAC. For example, cooling tower packing can be designed for liquid loading rates of approximately 4.1 L/m²s. Cooling towers typically operate at full continuous flows for maximum heat transfer because they are usually coupled to a process wherein the process efficiency increases with lower cooling water supply temperatures. As a result, cooling towers do not have incentive to run at low liquid flows that risk reduction in heat transfer through uneven wetting of the packing. The liquid-to-gas ratio for DAC applications is about ten times less than that of cooling tower applications.

Conventionally, a splash box type design is used in cooling towers for filling a top basin with liquid. A splash box design can lead to impingement of liquid in the top basin, as the entire stream of liquid can hit the splash plate and may produce foam when the liquid (and traces of organics) mixes with air. When incorporating a splash box design in a DAC gas-liquid contactor application, the traces of organics, such as grease, can enter or leach into the liquid including the CO₂ capture solution from the piping, pumps, basins or the environment and promote foaming and associated operational challenges. For example, foaming can lead to uneven distribution of liquid onto the packing and difficulties in measuring liquid level in the top basin. Foaming can also be a safety hazard as it can lead to overflows from the top basin. Downstream equipment can sometimes have challenges in handling and separating organics and foam.

Some areas where standard cooling tower design elements were not optimal for DAC include: specific surface area, liquid holdup efficiency, and capital cost per frontal area.

For mass transfer from a gas to a liquid, including the CO₂ capture flux, a key property to control and/or optimize is liquid surface area which is directly related to fill specific surface area and liquid hold-up efficiency. In terms of specific surface area, cooling towers, with heat transfer as a design objective, run relatively high liquid to air ratios which results in a relatively thick liquid film, effectively smoothing any microfeatures in the fill shape. Additionally, a smooth surface prevents biological fouling. For DAC, biological fouling is not an issue due to the high pH solution. Low liquid flow rates and/or intermittent liquid flow rates can be supported in DAC applications and are desirable to reduce the cost of pumping liquid. Further, low liquid flow rates result in a lower pressure drop, which reduces the fan energy requirements.

Fill liquid hold-up efficiency is partially determined by physical wettability which is directly related to surface energy and partially by the completeness of coverage as the liquid travels from the top of the fill to the bottom which is determined by geometry and surface structure of the fill. Compared to metal materials, PVC has a lower surface energy which results in larger contact angles and decreased wetting. As DAC generally uses low liquid flow rates, it can be significantly more important to control and optimize surface wettability in DAC than in cooling tower applications.

In some cases, preventing plume re-ingestion can be more important to DAC than in cooling towers, given the unique properties of the plume. The gas that is discharged from an outlet of a gas-liquid contactor, which is generally a CO₂-lean gas in DAC applications, is referred to as a plume. A plume exiting an air contactor (e.g., gas-liquid contactor) tends to be cooler and less buoyant than the plumes exiting conventional cooling towers. For example, for some DAC applications the gas-liquid contactor continuously pulls in fresh air for CO₂ capture through the inlet at the front or sides of the gas-liquid contactor structure, and vents the low-CO₂ air (e.g., the CO₂-lean gas) out of the top through a fan stack (or cowling) that partially encloses the fan of the gas-liquid contactor. In some cases, the gas intake sections located on one or more sides of the contactor structure, are nonparallel to the ground, such that the gas-liquid contactor draws in air in a direction that is substantially parallel to the ground (e.g., cross-flow design gas-liquid contactors). The wind direction may cause the CO₂-lean gas to be drawn back into the gas-liquid contactor inlet. This phenomenon is known as plume re-ingestion. Several design considerations can be made to reduce plume re-ingestion.

The present systems and methods, designed for capturing CO₂ from dilute gas sources (e.g., atmospheric or ambient air), address problems of significance to DAC, including but not limited to rainwater ingress, degradation of material from capture solution, liquid splashing, foaming, larger packing depth, or plume reingestion.

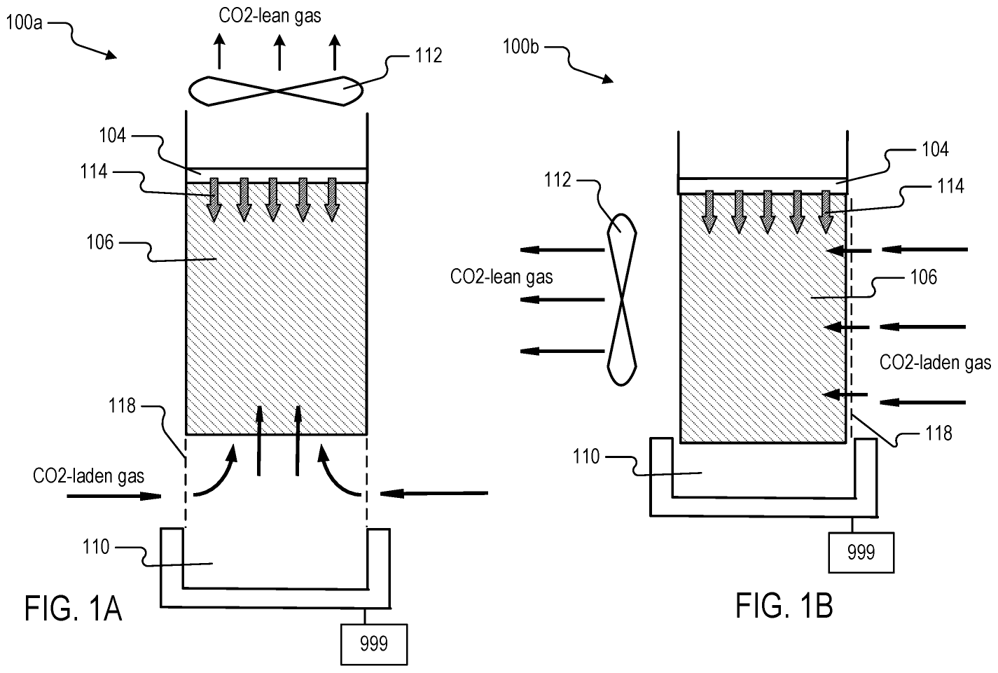

FIG. 1A and FIG. 1B show illustrative examples of interfaces between a packing 106 and other elements of gas-liquid contactors 100a, 100b (collectively and individually 100) according to the present disclosure. Gas-liquid contactor 100 can include elements such as a liquid distribution system 104, a fan 112 and its associated motor, a gas intake 118, a CO₂ capture solution 114, packing 106, and a bottom basin 110. In some implementations (not illustrated), gas-liquid contactor 100 can include a housing that partially encloses other elements of gas-liquid contactor 100 and a frame comprising structural members that provide structural stability to gas-liquid contactor 100. Liquid distribution system 104 can include a set of nozzles, a top basin, a pressurized header, or a combination thereof, configured to distribute CO₂ capture solution 114 onto packing 106. For example, the top basin can hold CO₂ capture solution 114 and nozzles positioned at the floor of the top basin can flow CO₂ capture solution 114 onto packing 106. CO₂ capture solution 114 can flow through the packing material via gravity and be collected in bottom basin 110. Gas-liquid contactor 100a of FIG. 1A includes a liquid distribution system 104 that is configured to flow CO₂ capture solution 114 in a counter current flow configuration (also known as counterflow) relative to CO₂-laden air. In a counterflow configuration, CO₂ capture solution 114 can flow through packing 106 in a direction that is substantially parallel to and opposite of the CO₂-laden air. Gas-liquid contactor 100b of FIG. 1B includes a liquid distribution system 104 that is configured to flow CO₂ capture solution 114 in a crossflow configuration relative to CO₂-laden air. In a crossflow configuration, CO₂ capture solution 114 can flow through packing 106 in a direction that is substantially nonparallel (e.g., perpendicular) to the CO₂-laden air.

CO₂ capture solution 114 can be transferred from bottom basin 110 for recirculation (e.g., pumped to liquid distribution system 104), downstream processing (e.g., for regeneration, purification, filtration and the like), or a combination thereof. A gas stream (e.g., CO₂-laden air) can flow into gas intake 118, through packing 106, and out of gas-liquid contactor 100 outlet by operating fan 112 and its associated motor. In some cases (not illustrated), at least a portion of the outlet of gas-liquid contactor 100 is covered by a drift eliminator material. The outlet is downstream of fan 112 and discharges CO₂-lean gas. The drift eliminator material can be positioned between packing 106 and outlet to prevent CO₂ capture solution 114 from exiting gas-liquid contactor 100 along with the gas stream. In some cases, gas intake 118 can include inlet louvers, protective screens, or a combination thereof.

Gas-liquid contactor configurations that employ packing as described in the present disclosure can include one or more commercially available gas-liquid contacting equipment types, including but not limited to chemical scrubbers, HVAC systems, and cooling towers. Packing can be designed and positioned within a gas-liquid contactor to enable liquid distribution and gas flow in one or more of a crossflow or a counterflow configuration. In some implementations, gas-liquid contactors can include a blower instead of or in addition to a fan to draw CO₂-laden air. In some implementations the fan or blower can be in an induced flow configuration, and in other implementations can be in a forced flow configuration.

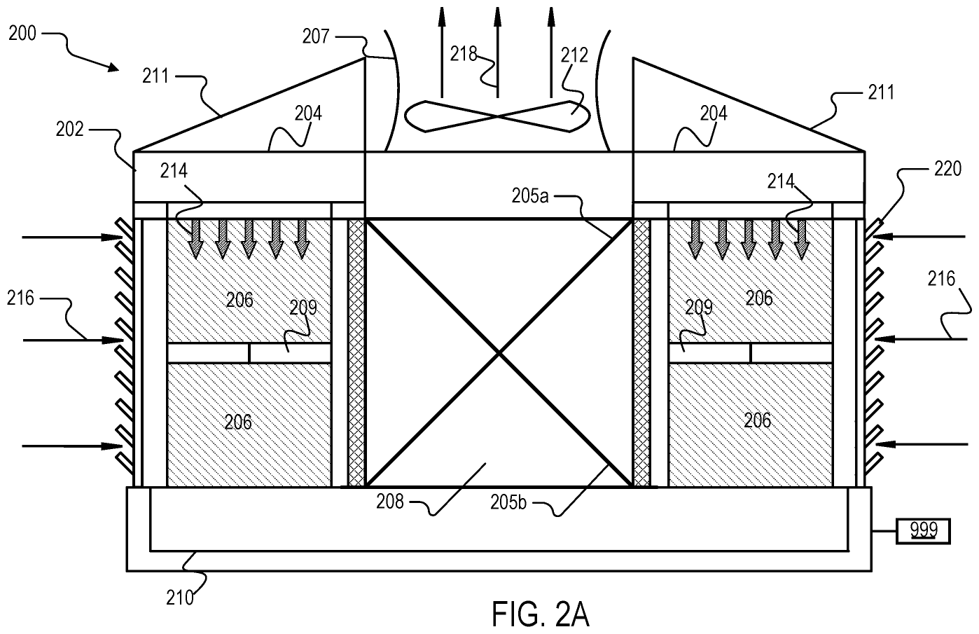

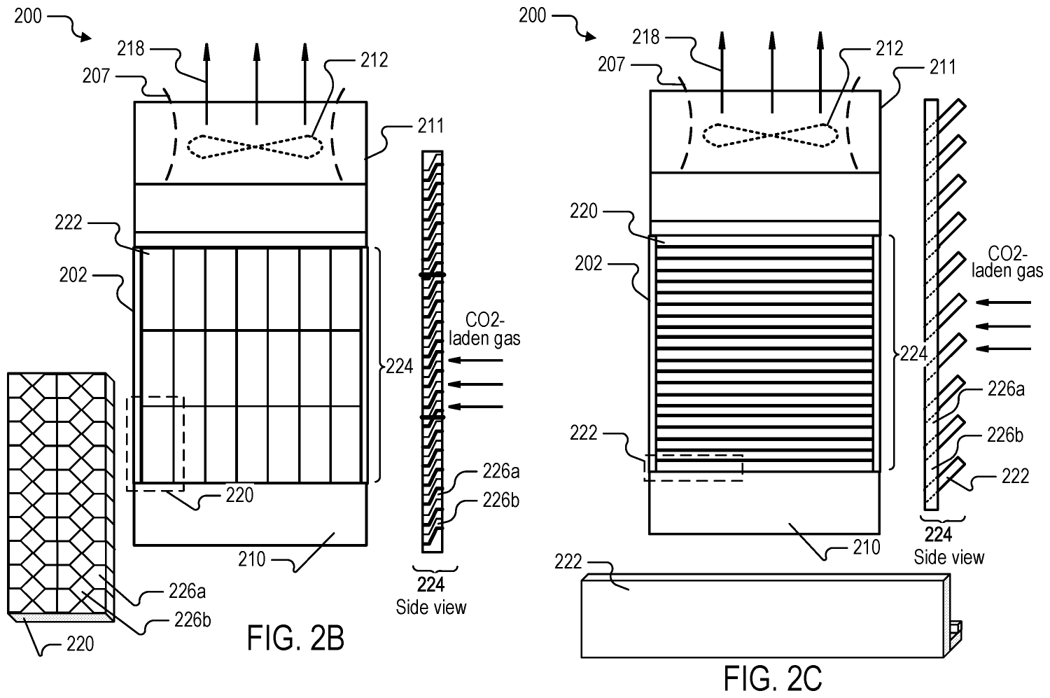

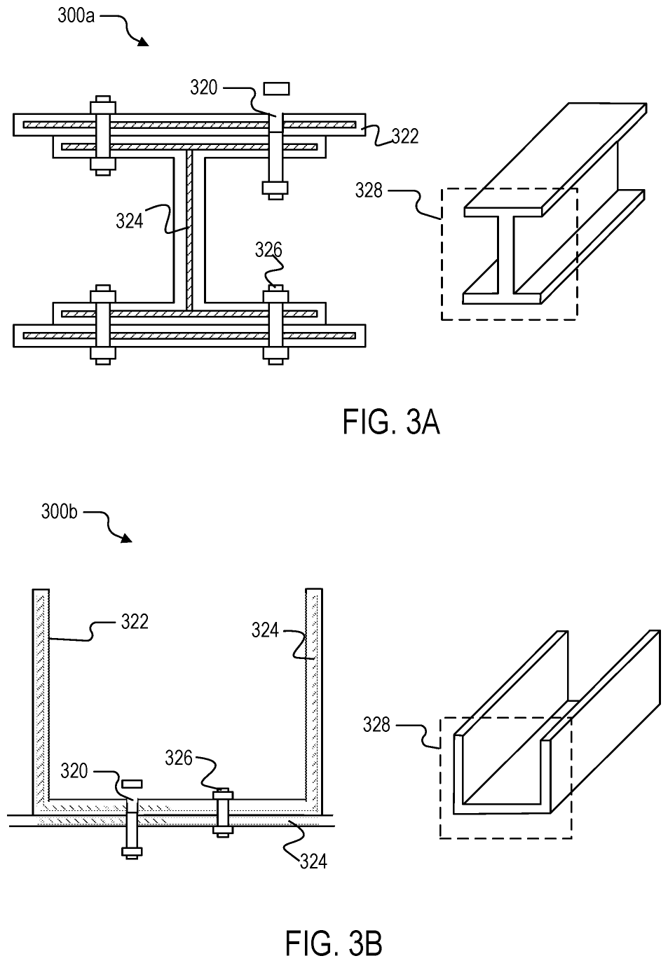

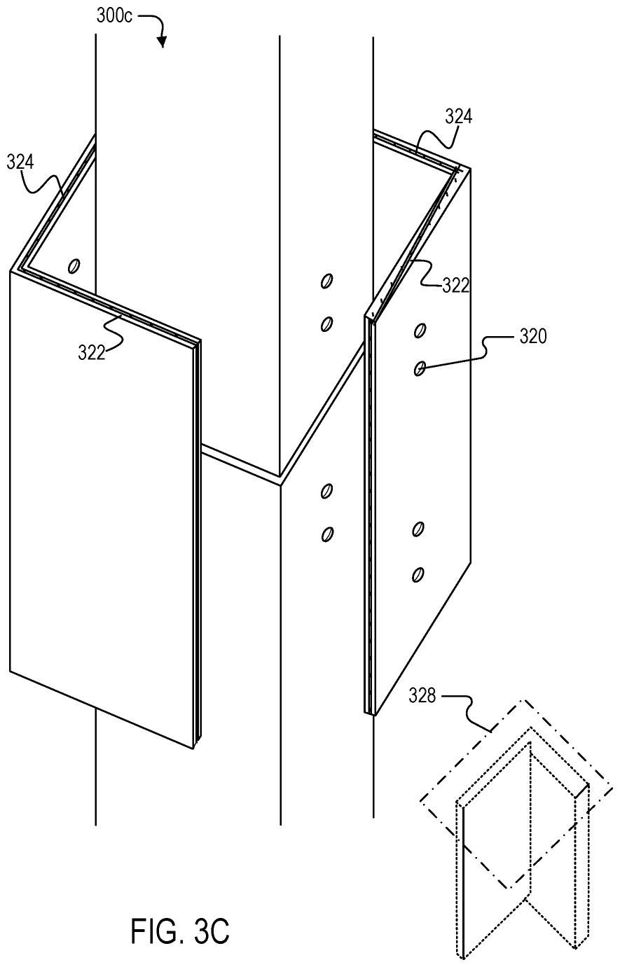

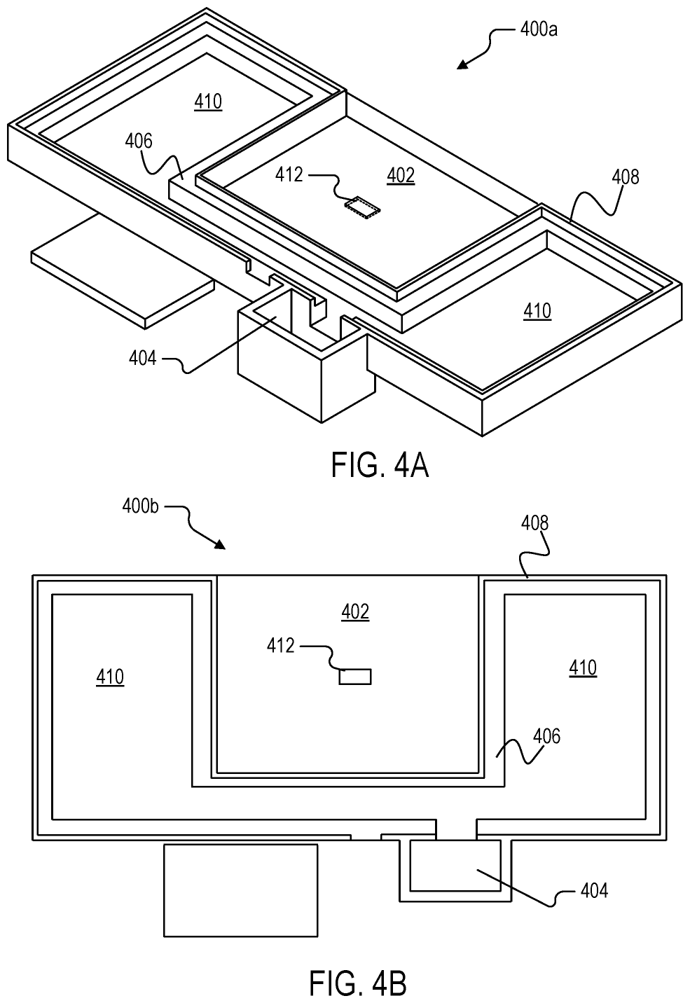

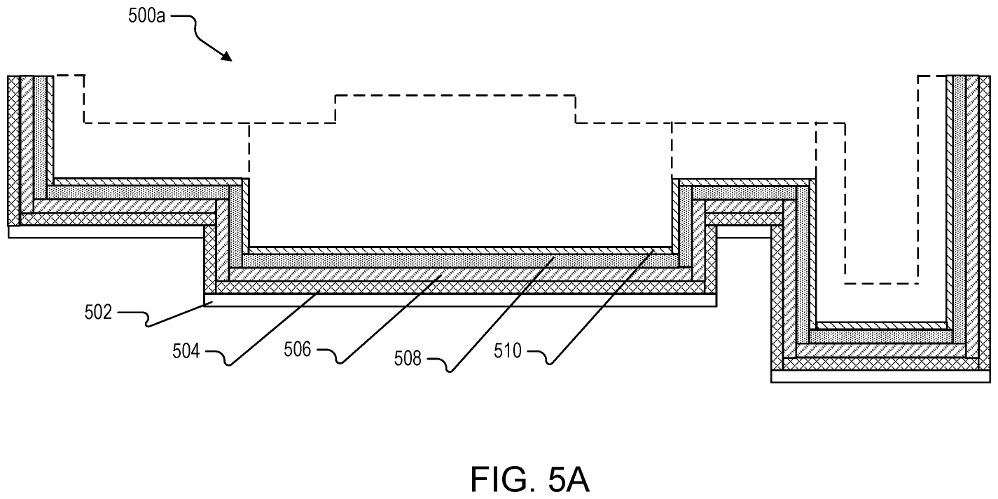

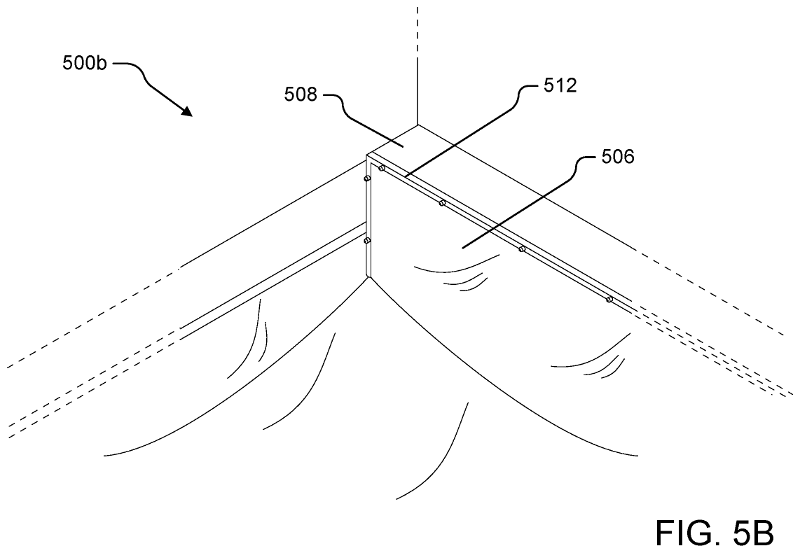

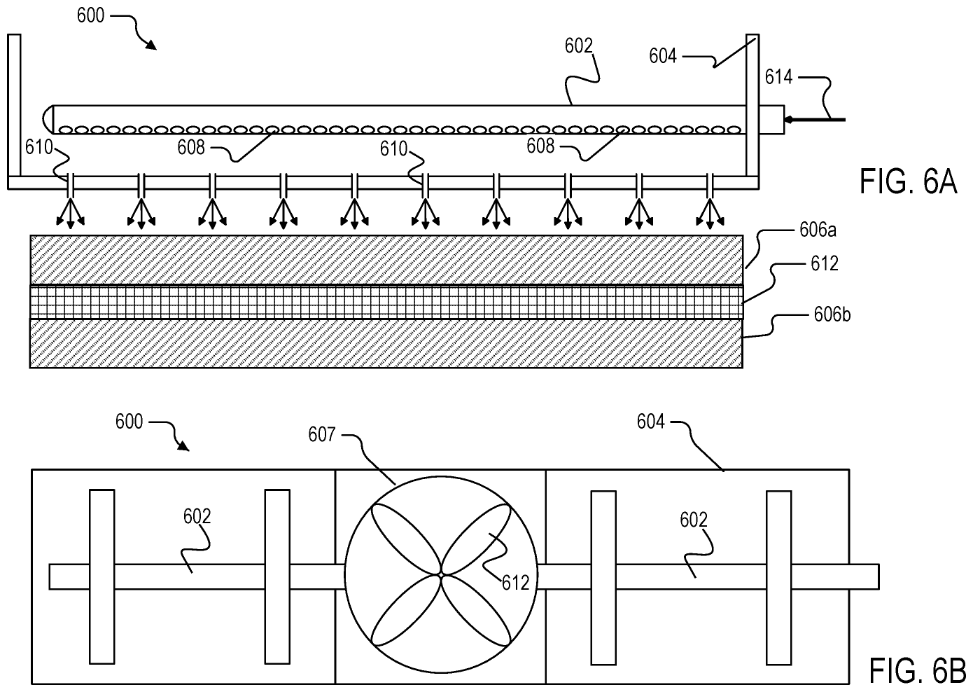

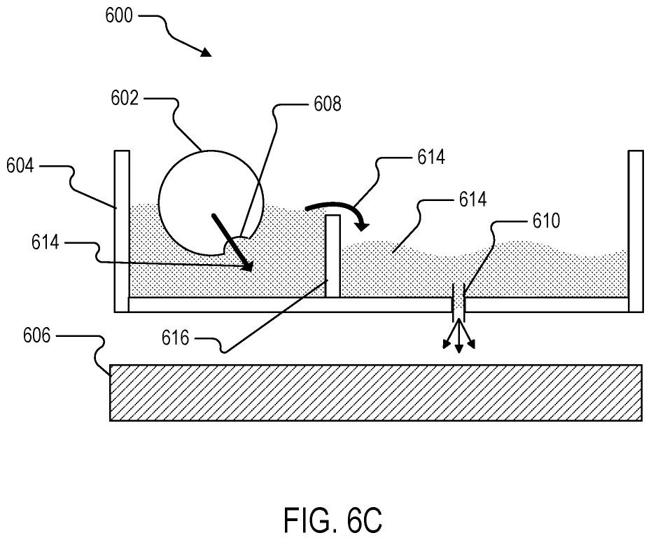

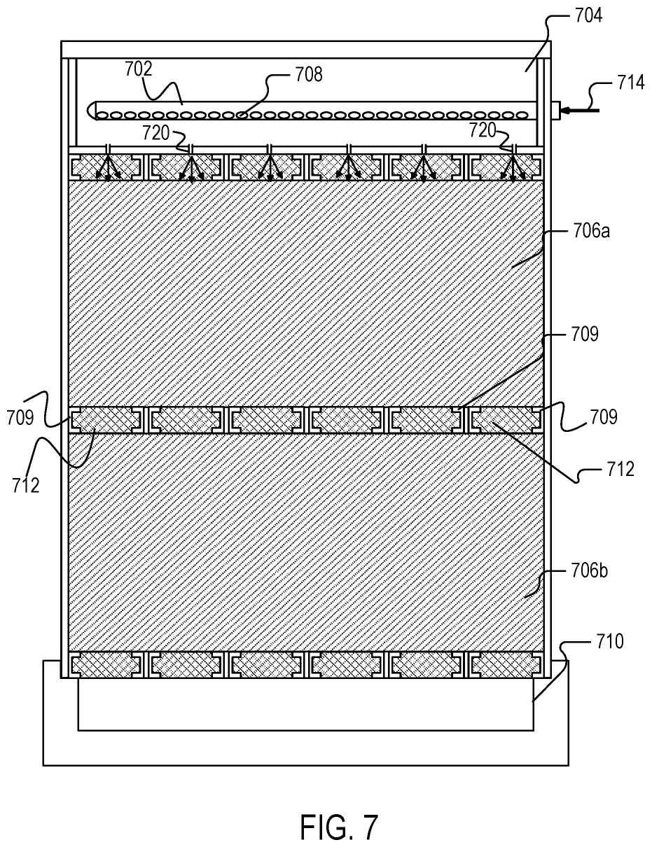

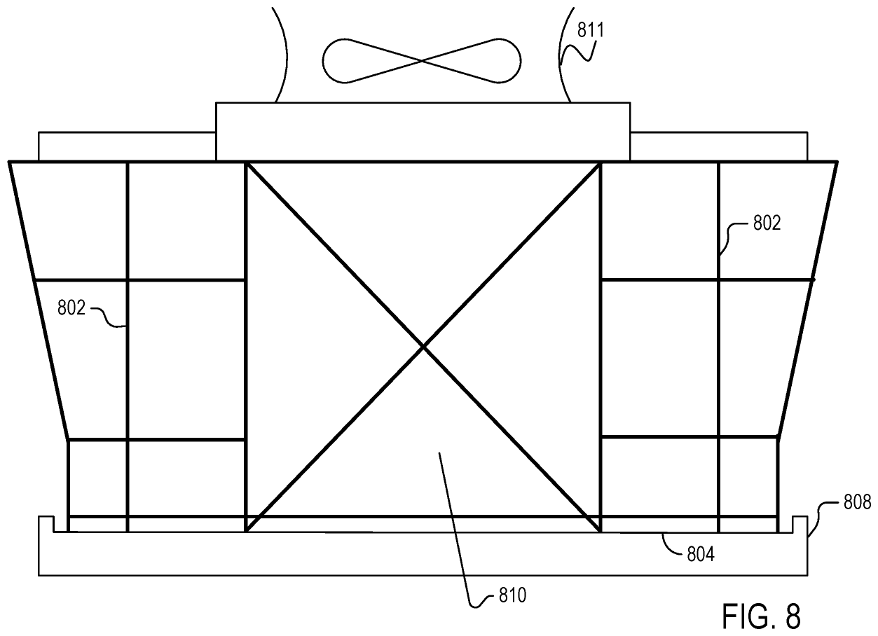

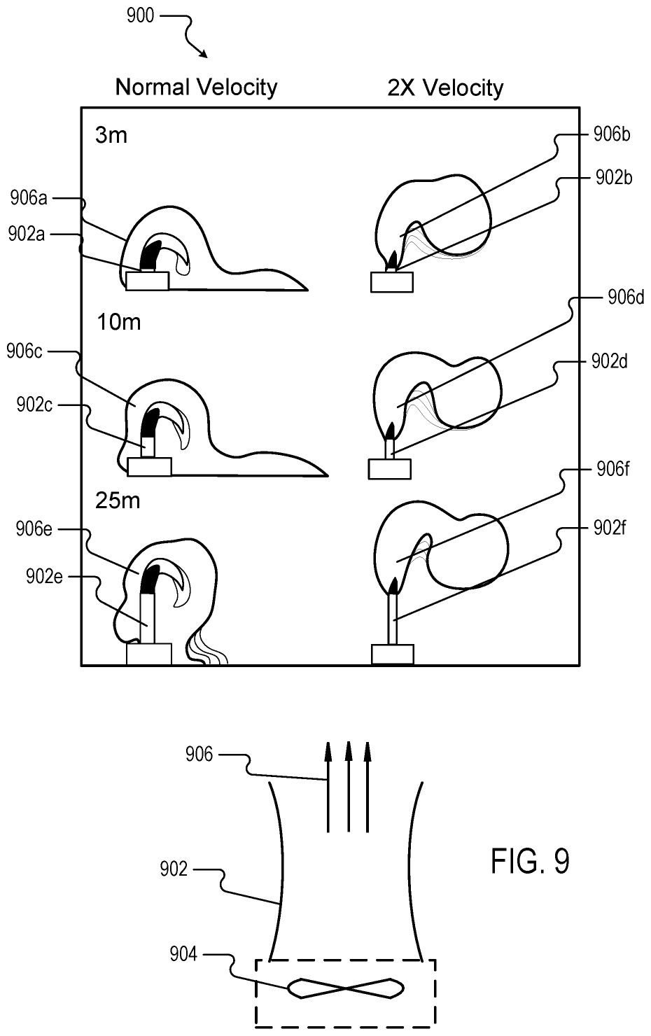

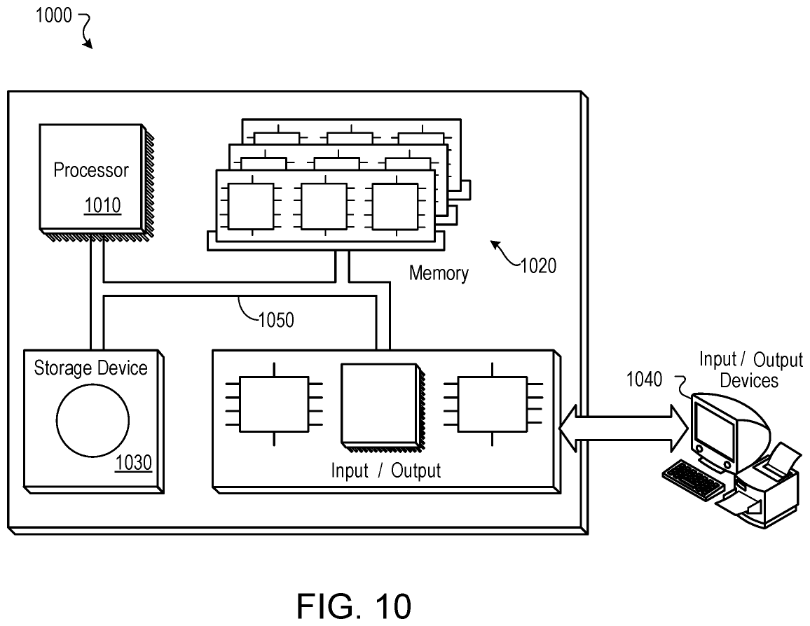

In some implementations, elements of gas-liquid contactor 100a and 100b are combinable with any of the elements described in FIG. 1 through FIG. 10. For example, gas-liquid contactor 100a and 100b can include louvers 220 of FIG. 2A to 2C, FRP structures 300 of FIG. 3A to 3C, basin 400 of FIG. 4, basin containment system 500 of FIG. 5A to 5B, liquid distribution system 600 of FIG. 6, packing supports and baffles 712 of FIG. 7, raised walls 804 of FIG. 8, fan stacks 902 of FIG. 9, or control system 1000 of FIG. 10.

FIG. 2A shows cross-sectional side view of an example dual-cell crossflow gas-liquid contactor 200 according to the present disclosure. Gas-liquid contactor 200 includes a housing 202 coupled to a number of interconnected structural members 205a, 205b (only two called out, collectively 205). Structural members 205 provide structural support and stability to the gas-liquid contactor 200. The housing 202 partially encloses and protects other elements of gas-liquid contactor 200, including packing sections 206, a plenum 208, top basins 204, and packing supports 209. The housing 202 includes openings that allow for intake of CO₂-laden gas into the gas-liquid contactor 200.

In another aspect, the gas-liquid contactor 200 includes accessibility to internal sections of the gas-liquid contactor 200. For example, one or more of a window, an access hatch, or a door may be provided to access the packing 206 and other internals of the gas-liquid contactor 200. For example, doors may be cut into the inlet louvers to access internal sections without having to remove the packing 206. This can be beneficial for maintenance of internal sections of the contactor 200 and can also allow accessibility to the packing 206 for inspection of any contaminant build ups over the packing 206. Contaminants can impede fluid flow and/or reduce the active gas-liquid interfacial area, and thus can reduce the efficiency of the gas-liquid contactor 200.

Gas-liquid contactor 200 can include a liquid distribution system that is configured to flow a CO₂ capture solution onto the packing 206. The liquid distribution system can include a set of nozzles, a top basin, a pressurized header, or a combination thereof, configured to distribute CO₂ capture solution onto the packing 206. Gas liquid contactor 200 includes one or more basins, such as top basins 204 and a bottom basin 210. Top basins 204 can hold or store a CO₂ capture solution 214 (e.g., CO₂ sorbent). CO₂ capture solution 214 can be distributed from top basins 204 (e.g., through pumping or gravity flow or both) over the packing 206. For example, the top basin 204 can hold CO₂ capture solution 214 and nozzles positioned at the floor of the top basin can flow CO₂ capture solution 214 onto packing 206. CO₂ capture solution 214 can flow through the packing material via gravity and be collected in bottom basin 210. In some cases (not illustrated), there can be more than one bottom basin 210. Packing 206 can include one or more packing sections. CO₂ capture solution flows through the packing 206 and eventually into bottom basin 210. As the CO₂ capture solution 214 flows through and over the packing 206, CO₂-laden gas is circulated (e.g., by operating a fan 212) through the packing 206 to contact the CO₂ capture solution 214. A mixed fluid is formed by contacting the fluids and at least a portion of CO₂ within the CO₂-laden gas is absorbed by the CO₂ capture solution 214 to yield a CO₂-lean gas. While a crossflow configuration is illustrated in FIG. 2A, countercurrent or coaxial flow configurations can also be employed.

The CO₂-lean gas flows into a plenum 208 positioned adjacent to packing 206 and is discharged through a fan stack 207 by operating fan 212. Pressure drop across packing 206 can be a factor in designing fan 212. In some implementations, certain packing 206 designs can lower the pressure drop across the packing. This can enable increased gas velocity while keeping overall pressure drop of the gas-liquid contactor system relatively constant. The increased gas velocity can be achieved via a larger fan or higher fan stack. A larger fan can be associated with a larger fan motor, more impeller blades, or custom pitch of fan blades. In some implementations, it may not be feasible to employ packing with a low pressure drop, and instead the fan 212 can be designed to accommodate large system pressure drops.

In some aspects, a CO₂-laden gas can include ambient air. The CO₂ content in ambient or atmospheric air can be dilute (e.g., less than about 1 vol %). For example, currently the CO₂ concentration in atmospheric air can be about 400 to 415 ppm, although this value is likely to keep rising unless emissions are properly mitigated. Top basins 204 are positioned within the housing 202 and can be at least partially covered by one or more cover plates 211. Cover plates 211 can be removably attached or fixed to the housing. In some aspects, the top basin 204 of the gas-liquid contactor 200 can include cover plates 211 that prevent rainwater ingress through the top basins. The cover plates 211 can also prevent or reduce the loss of CO₂ capture solution 214 from the gas-liquid contactor 200 to the surrounding environment.

The bottom basins 210 positioned beneath the packing 206 of the gas-liquid contactor 200 can collect the CO₂ capture solution 214. The CO₂ capture solution 214 in bottom basin 210 can be recirculated for further CO₂ capture and/or pumped to a downstream process such as a capture solution regeneration system. The gas-liquid contactor 200 can include packing supports 209 that intervene packing sections. Packing supports 209 can be positioned between a first packing section and a second packing section in the packing 206. Packing supports 209 can be positioned between the top basins 204 and bottom basins 210. For example, packing 206 of the contactor 200 can receive additional support through the packing supports 209 so that the weight of liquid hold up in the top section of packing 206, along with the weight of the top section of the packing 206 itself, does not crush the bottom portion of the packing 206. For example, a 24 ft. tall packing 206 may include a top packing section and a bottom packing section that each have a height of 12 ft., and the packing support 209 can be positioned in between the top packing section and the bottom packing section of packing 206. In some aspects (not illustrated), the gas-liquid contactor 200 may not include a packing support.

CO₂ capture solution 214 is more viscous and denser compared to, for example, water or treated water as conventionally used in cooling tower applications. In some implementations, packing 206 can include a fill designed for capturing CO₂ from dilute sources. For example, gas-liquid contactor 200 can operate at low liquid flow rates of CO₂ capture solution 214, which can affect the flow regime of the CO₂ capture solution 214. For example, low liquid flow rates can tend towards rivulet flow, which is undesirable because it can reduce the gas-liquid interface area available for mass exchange from the CO₂-laden gas to the CO₂ capture solution 214. On the other hand, certain properties such as the free energy of the solid surface of packing 206 and the density, viscosity, and surface tension of the CO₂ capture solution 214, can be exploited to maintain a film flow. At least some of these properties of CO₂ capture solution 214 can differ from those of water, which is the typical liquid in cooling tower applications, due to the high concentrations of dissolved sorbents such as caustic sorbents (e.g. KOH or NaOH).

In some aspects, the total number of packing blocks may be minimized in a packing volume to reduce the number of packing interfaces between the different blocks. For instance, an example dimension of the packing 206 (packing volume) in the gas-liquid contactor 200 may be 24′×10′×24′. Packing blocks that can be used to attain these dimensions can range from 2′×2′×2′ to 2′×2′×12′ (dimensions have been provided in the L×W×H format in these cases). The blocks are aligned together to attain the desired packing volume. This may produce one or both of the following two issues: 1) the blocks can be misaligned, e.g., the pattern on a face of one packing block is not fully aligned with the pattern on a packing face adjacent to it, and 2) there may be space or a gap between the two packing blocks. These issues between the blocks can lead to improper distribution of CO₂ capture solution 214 from one packing block to another and can add to a pressure drop across the packing 206.

In some aspects, the gas-liquid contactor 200 can address these issues by reducing the number of blocks used in the packing volume. In general, the larger the size of blocks in a given packing volume, the smaller the number of interfaces between adjacent blocks. A single monolith of packing to fill the packing volume can avoid such misalignment, leaving no substantial gaps, to provide a homogenous flow of the capture solution through the packing 206. Such a design can also reduce the pressure drop across the packing 206. The monolith in the above example refers to a single block of packing, e.g., 24′×10′×24′, that fills the entire desired dimension of the gas-liquid contactor housing 202. Optionally, the monolith can be coupled to a set of drift eliminators, which are typically positioned downstream of the packing. In some cases, the monolithic packing block can be supported by one or more packing supports. The packing 206 is a 3-D structure, where the face is conventionally designed, such as a cube face or a cuboid face.

In some cases, gaps can exist between the packing and the housing and/or between each of the one or more packing sections (e.g., packing blocks). In the present disclosure, “substantially no gaps” can mean that the volume of the gas-liquid contactor that is configured to hold the packing is at least 98% occupied by the one or more packing sections, and that the cross-sectional area of the inlet of the gas-liquid contactor is at least 98% covered by the one or more packing sections.

As previously mentioned, the solution properties of CO₂ capture solution can differ from that of cooling water and can change based on temperature and composition. Accordingly, there are ways in which the solution properties could be modified for better CO₂ capture performance. For example, density and viscosity of the CO₂ capture solution 214 can vary depending on the composition of such solution and the temperature. For example, at temperatures of 20° C. to 0° C., a capture solution comprising 1 M KOH and 0.5 M K₂CO₃ can have a density ranging from 1115-1119 kg/m³ and a viscosity ranging from 1.3-2.3 mPa-s. In another example, at temperatures of 20° C. to 0° C., a capture solution comprising 2 M KOH and 1 M K₂CO₃ can have a density ranging from 1260-1266 kg/m³ and a viscosity ranging from 1.8-3.1 mPa-s. In comparison, water has a density of 998 kg/m³ and viscosity of 1 mPa-s at 20° C.

In some cases, lowering the surface tension of the CO₂ capture solution closer to that of water can improve the ability of the solution to wet the packing material. Adjusting the surface tension of the CO₂ capture solution can be accomplished by diluting the concentration or adding a surfactant.

In some cases, the type of packing 206 or the installation of the packing 206 can lead to potential issues with liquid splash-out of CO₂ capture solution, which can sometimes be hazardous and/or require additional make up CO₂ capture solution. In wet climates it can also be important to prevent rainwater ingress so that the CO₂ capture solution is not diluted. Thus, it can be advantageous to implement barriers, such as louvers, that are permeable to CO₂-laden gas but impermeable to liquid.

FIG. 2A-2C show views of example gas-liquid contactor 200 that includes structured louvers 220 or slatted louvers 222 (sometimes referred to as blade-style louvers). In some implementations (not illustrated), gas-liquid contactor 200 can include a combination of structured louvers 220 and slatted louvers 222. Inlets 224 of gas-liquid contactors 200 can be at least partially covered by structured louvers 220, slatted louvers 222, or a combination thereof.

FIG. 2B shows a front view of an example gas-liquid contactor 200 inlet 224 that is at least partially covered by structured louvers 220. Structured louvers 220 can have a dominant face that includes openings 226a, 226b (only two called out to avoid clutter; collectively 226) that allow CO₂-laden gas to enter the inlet 224 of gas-liquid contactor 200 and then flow into the packing 206. Structured louvers 220 can include one or more sheets that are connected to one another to openings 226. The one or more sheets can be arranged to form a lattice, grid, honeycomb, or a combination thereof, with openings 226 defined therebetween. In some implementations, structured louvers 220 can include one continuous sheet that is integrally formed, wherein the edges of the sheets define the openings 226 of the structured louvers 220. In some implementations (not illustrated), structured louvers 220 can be integrally formed with the packing 206.

In some cases, some CO₂ capture solution can deflect, for example from surfaces of supporting components such as angles, rods, and the like, and be ejected out of structured louvers 220. To mitigate liquid splash-out, it can be advantageous to employ slatted louvers 222 in addition to structured louvers 220. FIG. 2C shows a front view of an example gas-liquid contactor 200 inlet 224 that is at least partially covered by slatted louvers 222. Slatted louvers 222 can each be shaped as panel or blade with a flat face. In some implementations, slatted louvers 222 can have cross-sections that include a curve or angle (e.g., is L-shaped, J-shaped, etc.) to form a gutter that collects and drain liquid (e.g., CO₂ capture solution, rainwater). Liquid droplets can contact the flat face and travel down to the gutter rather than splashing out into the surrounding environment.

In cases where gas-liquid contactor 200 employs both structured louvers 220 and slatted louvers 222, it can be beneficial to position slatted louvers 222 upstream (in terms of CO₂-laden gas flow) of structured louvers 220. This allows structured louvers 220 to at least partially block large quantities of liquid splashing out and slatted louvers 222 to at least partially block smaller portions of liquid that bypass the structured louvers 220, thus providing more than one barrier. In general, the CO₂-laden gas can first flow through the slatted louvers 222 and then the structured louvers 220 that are positioned downstream.

Structured louvers 220 and slatted louvers 222 can be oriented to direct the flow of CO₂-laden gas into the packing 206. Slatted louvers 222 can be independently controllable. For example, an upper portion of slatted louvers 222 can be open with a lower portion of slatted louvers 222 closed. Large volumes of CO₂-laden gas may need to be processed and it can be beneficial to shield gas-liquid contactor 200 from debris, animals, and insects. Structured louvers 220 and slatted louvers 222 may aid in this, in addition to selectively letting in and directing CO₂-laden gas flow. The dominant face of each structured louver 220 can be substantially parallel with the inlet 224 (e.g., front face) of gas liquid contactor 200. The flat face of each slatted louver 222 can be oriented at a substantially nonparallel angle relative to the inlet 224 (e.g., front face) of the gas-liquid contactor 200.

In some implementations, inlet 224 of gas-liquid contactor 200 can include supporting components such as angles, straps, rods, and the like to hold other elements in position. These components can sometimes exacerbate liquid splash-out by providing surfaces that deflect the liquid out of the louvers. In some cases, some of these surfaces or portions of the components can be modified or removed so that liquid is not deflected and ejected out of the louvers. In some cases, rainwater can enter the gas-liquid contactor through openings in the louvers and then flow down to the bottom basin 410 and contaminate or dilute the CO₂ capture solution. In some implementation (not illustrated), a cover can be installed above the structured louvers 220 and/or slatted louvers 222 to prevent rainwater from entering through the inlet.

The process streams in the gas-liquid contactor systems, as well as process streams within any downstream processes with which the gas-liquid contactor systems are fluidly coupled, can be flowed using one or more flow control systems (e.g., control system 999) implemented throughout the system. A flow control system can include one or more flow pumps, fans, blowers, or solids conveyors to move the process streams, one or more flow pipes through which the process streams are flowed and one or more valves to regulate the flow of streams through the pipes. Each of the configurations described herein can include at least one variable frequency drive (VFD) coupled to a respective pump that is capable of controlling at least one liquid flow rate. In some implementations, liquid flow rates are controlled by at least one flow control valve.

In some embodiments, a flow control system can be operated manually. For example, an operator can set a flow rate for each pump or transfer device and set valve open or close positions to regulate the flow of the process streams through the pipes in the flow control system. Once the operator has set the flow rates and the valve open or close positions for all flow control systems distributed across the system, the flow control system can flow the streams under constant flow conditions, for example, constant volumetric rate or other flow conditions. To change the flow conditions, the operator can manually operate the flow control system, for example, by changing the pump flow rate or the valve open or close position.

In some embodiments, a flow control system can be operated automatically. For example, the flow control system can be connected to a computer or control system (e.g., control system 999) to operate the flow control system. The control system can include a computer-readable medium storing instructions (such as flow control instructions and other instructions) executable by one or more processors to perform operations (such as flow control operations). An operator can set the flow rates and the valve open or close positions for all flow control systems distributed across the facility using the control system. In such embodiments, the operator can manually change the flow conditions by providing inputs through the control system. Also, in such embodiments, the control system can automatically (that is, without manual intervention) control one or more of the flow control systems, for example, using feedback systems connected to the control system. For example, a sensor (such as a pressure sensor, temperature sensor or other sensor) can be connected to a pipe through which a process stream flows. The sensor can monitor and provide a flow condition (such as a pressure, temperature, or other flow condition) of the process stream to the control system. In response to the flow condition exceeding a threshold (such as a threshold pressure value, a threshold temperature value, or other threshold value), the control system can automatically perform operations. For example, if the pressure or temperature in the pipe exceeds the threshold pressure value or the threshold temperature value, respectively, the control system can provide a signal to the pump to decrease a flow rate, a signal to open a valve to relieve the pressure, a signal to shut down process stream flow, or other signals.

In some implementations, elements of gas-liquid contactor 200 are combinable with any of the elements described in FIG. 1 through FIG. 10. For example, gas-liquid contactor 200 can include FRP structures 300 of FIG. 3A to 3C, basin 400 of FIG. 4, basin containment system 500 of FIG. 5A to 5B, liquid distribution system 600 of FIG. 6, packing supports and baffles 712 of FIG. 7, raised walls 804 of FIG. 8, fan stacks 902 of FIG. 9, or control system 1000 of FIG. 10.

Conventional materials of construction (MOC) used in commercial cooling towers include wood, carbon steel, and fiber reinforced polyester standard resin. However, wood, carbon steel, aluminum and polyester standard resin typically do not hold up well in caustic solutions such as KOH or NaOH. These materials, which are standard for cooling towers, are considered incompatible with caustic solutions as they tend to degrade with exposure over time. Since gas-liquid contactors 200 can employ CO₂ capture solutions 214 that include caustic solutions, conventional MOCs used in cooling towers are often not ideal. Some structures that are used to construct gas-liquid contactors can include caustic-compatible MOCs, including but not limited to some corrosion-resistant steel alloys, stainless steels (e.g., 304 stainless steel), or fiberglass reinforced polyester (FRP). Structures that include FRP as a caustic-compatible MOC are referred to herein as FRP structures. FRP structures can be more durable in some CO₂ capture solutions in comparison to structures made from the more traditional materials.

FIGS. 3A, 3B, and 3C show cross-sectional views and a perspective view of example FRP structures including lined openings and cut ends for a gas-liquid contactor system according to the present disclosure. FIGS. 3A, 3B, and 3C show an I-beam 300a, a U-beam 300b, and a beam connector 300c, respectively.

I-beam 300a, U-beam 300b, and beam connector 300c are example FRP structures of the gas-liquid contactor 200 that include a caustic-compatible MOC. The caustic-compatible MOC is chosen for its resistance to degradation from caustic components of CO₂ capture solution 214. In some cases, the caustic-compatible MOC can resist degradation from solutions of up to 10% KOH. In some implementations, I-beam 300a, U-beam 300b, and beam connector 300c can be components that will at least partially contact the CO₂ capture solution 214 (e.g., have at least a portion of surface area exposed to or wetted by CO₂ capture solution 214). I-beam 300a, U-beam 300b, and beam connector 300c each comprise an FRP material 322 at least partially covering one or more sections of fiberglass 324. FRP 322 can include polyester standard resin, vinyl ester resin, or a combination thereof. For gas-liquid contactors 200 that use a caustic CO₂ capture solution 214, it may be advantageous for example components I-beam 300a, U-beam 300b, and beam connector 300c to include a vinyl ester resin instead of a polyester resin in FRP 322. Vinyl ester resin is not used widely in cooling tower industry as it costs more than the polyester standard resin, but the vinyl ester is significantly more resistant to degradation from caustic solutions (e.g., KOH, NaOH). Polyester is more likely to be prone to hydrolysis upon prolonged exposure with caustic solutions in comparison to vinyl ester. For example, Bisphenol A group of the vinyl ester has demonstrated good resistance to caustic solutions. The fiberglass 324 can include Advantex® glass, EC-R glass, E-glass, or a combination thereof. Advantex® glass can be better than other glasses (such as standard E-glass) for reinforcement of the FRP for alkaline applications that can be corrosive. In addition to compatibility with caustic solutions, it can be important that the resin in FRP 322 and the fiberglass 324 (e.g., the FRP composites) form an effective bond to form a mechanically stable FRP structure. For example, a type of fiberglass 324 may have excellent resistance to caustic solutions, but if the type of fiberglass 324 does not form an effective bond with the resin in FRP 322, it can cause permeation of the caustic solution into the FRP 322. In some cases, gas-liquid contactors 200 are built for operation upwards of 10 years, and such permeation can damage the structural integrity of the FRP 322.

In some aspects, I-beam 300a, U-beam 300b, and beam connector 300c are example FRP structures that include attachment hardware 326 (e.g., bolts) and openings 320. The fiberglass 324 can provide 55-90% of the strength of the FRP structure. Corrosion can occur if a CO₂ capture solution including caustic solution gets into the fiberglass 324 through a crack, hole, a cut end 328, by chemical diffusion, or any combination of these. A cut end is a face or a side of the FRP structure that is formed when the FRP structure is terminated (e.g., by cutting, sawing, chopping, slicing, etc.), and thereby the fiberglass 324 is potentially exposed. To prevent corrosion caused by ingress of caustic solution, in one example, the openings 320 and cut ends 328 of the FRP structure may be lined with a sealant layer. The sealant layer can include the same resin that is used in the FRP, for example vinyl ester resin. In some implementations, the openings 320 can be lined with a protective sleeve that can be formed from PVC or another MOC that is compatible with CO₂ capture solution including caustic solution. In some implementations, attachment hardware 326 can be coated with a vinyl ester resin. Although attachment hardware 326 are illustrated as bolts, other types of attachment hardware can be used instead of or in addition to bolts, including fasteners, clamps, clips, pins, screws, tie-downs, or nails.

In some aspects, the gas-liquid contactor 200 can comprise a protective coating that is resistant to a CO₂ capture solution. For example, the protective coating can include a caustic-compatible coating or caustic-compatible material that is resistant to a caustic CO₂ capture solution. The protective coating can be applied to components of the gas-liquid contactor 200 that are wettable with CO₂ capture solution 214. For example, the protective coating can include a vinyl ester resin that is applied to the wettable components of the gas-liquid contactor 200. The term “wettable” can refer to components of the contactor 200 that come into contact with the CO₂ capture solution 214, including the structural members, housing, and basins.

In some cases, preventing contamination of the CO₂ capture solution 214 is important to performance. For example, bottom basins and/or top basins can be exposed to the ambient environment and thus can inadvertently receive a volume of water (e.g., rainwater) or particulates from the surroundings. For example, the rainwater can enter the gas-liquid contactor through the fan stack. Rainwater consumption can be a particular problem in wet climates and can lead to dilution of the CO₂ capture solution 214. The bottom basins 210 of the gas-liquid contactor 200 can include elements that keep most of the rainwater out of the gas liquid contactor or that isolate the rainwater in the plenum so that it is unlikely to contaminate or dilute CO₂ capture solution.

In some implementations, elements of FRP structures 300 are combinable with any of the elements described in FIG. 1 through FIG. 10. For example, gas-liquid contactor 100a and 100b of FIG. 1, or gas-liquid contactor 200 of FIGS. 2A-2C, can include FRP structures 300 of FIG. 3A through FIG. 3C.

FIGS. 4A and 4B show a perspective view and a top view, respectively, of an example bottom portion 400a, 400b (collectively 400) of a gas-liquid contactor, according to the present disclosure. Bottom portion (or “basin”) 400 of the gas-liquid contactor includes separating walls 406 and raised walls 408 that at least partially segregate a bottom basin 410 from a containment 402 below a plenum. Containment 402 includes a sump 412 that can drain liquid such as rainwater or a portion of CO₂ capture solution. Bottom basin 410 is adjacent to and fluidly coupled a contactor sump 404 that sends CO₂ capture solution to a downstream process (e.g., regeneration, purification, filtration system or the like).

CO₂ capture solution 214 flows or distributes over the packing 206 and can be collected in the bottom basin 410. CO₂ capture solution 214 in bottom basin 410 can be pumped back to top basin 204 of the gas-liquid contactor 200 and/or sent to a downstream process (e.g., a regeneration, purification, filtration system or the like) by operating contactor pump 404. Bottom basin 410 can include at least one MOC that is compatible with the CO₂ capture solution. In some implementations (not illustrated), bottom portion 400 of the gas-liquid contactor can include elements that prevent or reduce leakage of the CO₂ capture solution from bottom basin 410 to the external environment (e.g., soil, groundwater, etc.) in case of damage to bottom basin 410.

In some aspects, bottom basin 410 can include one or more MOCs that are compatible with CO₂ capture solution. For example, bottom basin 410 can include a plurality of basin sections that include (e.g., are at least partially formed from) stainless steel, concrete, HDPE, or a combination thereof. In some cases, one or more of these MOCs can resist degradation from caustic solution.

In another aspect, examples of MOCs that are compatible with CO₂ capture solution include high density polyethylene (HDPE), PVC, or other thermoplastics that are puncture-resistant. HDPE, PVC, or a combination thereof can be used to form at least a portion of bottom basin 410. For example, bottom basin 410 can include an HDPE basin that is flexible. In some cases, bottom basin 410 can include an HPDE basin that is more than or equal to 1 mm in thickness. In some cases, additional structural integrity components or basin support structures can be coupled to the HDPE basin. These basin support structures can include earth berms, lock blocks, or a combination thereof. In some aspects, the bottom basin 410 can include (e.g., be built from) concrete, steel, HDPE, or a combination thereof. Bottom basin 410 can include a wettable surface that is coated or lined with a protective coating, such as those of bottom basin 500 in FIG. 5. For example, the protective coating can include a caustic-compatible coating or caustic-compatible material that is resistant to a caustic CO₂ capture solution. A wettable surface of the bottom basin 410 includes any surface of the basin 210 that can contact the CO₂ capture solution 214.

In climates with large amounts of precipitation, rainwater ingress can be a concern of gas-liquid contactors, particularly for DAC applications, as rainwater can dilute the CO₂ capture solution. In some cases, rainwater can enter a plenum and containment 402 through a fan stack of a gas-liquid contactor, especially when the fan is not in motion. In some cases, rainwater can enter the plenum and containment 402 through the inlet of the gas-liquid contactor. For example, rainwater droplets can be entrained in the CO₂-laden gas (e.g., air) and flow from the gas inlet to the plenum due to significant air bypass. Air bypass occurs when a portion of the CO₂-laden gas (and sometimes the liquid entrained in the CO₂-laden gas) moves past the packing and/or drift eliminator material due to gaps or improper sealing and can reduce capture efficiency. In some cases, rainwater can enter the inlet of the gas-liquid contactor and then flow down to the bottom basin 410 and mix with the CO₂ capture solution 214. One approach to address the challenge of rainwater ingress into the plenum and containment 402 is to include one or more raised walls 408 that at least partially segregate the plenum and containment 402 from the bottom basin 410. The one or more raised walls 408 can be formed from concrete, stainless steel, or a combination thereof. In some aspects, the one or more raised walls 408 can prevent rainwater that enters the plenum from entering the bottom basin 410 and diluting the CO₂ capture solution 214 collected in the bottom basin 410.

In some cases, rainwater can enter the plenum and containment 402 from a gas inlet of a gas-liquid contactor due to significant air bypass and inefficiencies or gaps in drift eliminators. In some cases, a portion of CO₂ capture solution can enter the plenum and containment 402 from the packing due to liquid splashing. The portion of CO₂ capture solution and rainwater can be drained using a rainwater egress such as sump 412. In some implementations, sump 412 can be fluidly coupled to a drainpipe that flows rainwater, CO₂ capture solution, or a combination thereof out of containment 402. In some implementations, sump 412 can include a sump pump that flows rainwater, CO₂ capture solution, or a combination thereof to the bottom basin 410. From the bottom basin 410, the liquid can be sent to downstream processes (e.g., regeneration, purification, filtration system or the like). In some implementations, operating the sump pump in sump 412 can drain rainwater out of the containment 402 to send to a water treatment system. The plenum includes a plenum floor that can be sloped towards sump 412 to allow removal. In some cases, the plenum floor can be fitted with a drainage slope that is at least 2%.

Raised walls 408, which border the perimeter of the basin 410 and segregation walls 406 of the basin 410, can provide an additional benefit of supporting at least a portion of structural members of a gas-liquid contactor. By mounting structural members on the one or more raised walls 408 above a liquid level of the CO₂ capture solution 214 in the bottom basin 410, one can prevent the structural members from being submerged in the CO₂ capture solution 214. This can be beneficial in cases where the CO₂ capture solution 214 includes a caustic solution, because prolonged submergence of structural members formed from conventional cooling tower materials can lead to material degradation over time.

In some implementations, elements of bottom portion 400 of gas-liquid contactor are combinable with any of the elements described in FIG. 1 through FIG. 10. For example, gas-liquid contactor 100a and 100b of FIG. 1, or gas-liquid contactor 200 of FIGS. 2A-2C, can include bottom portion 400 of gas-liquid contactor of FIG. 4A and FIG. 4B.

FIG. 5A and FIG. 5B show a cross-sectional view and a perspective view, respectively, of an example bottom basin containment system 500a, 500b (collectively 500) for a gas-liquid contactor system according to the present disclosure.

Bottom basin containment system 500 can include one or more barriers that prevent or reduce degradation caused by exposure to CO₂ capture solution and prevent leakage of CO₂ capture solution in case the bottom basin 508 is damaged. Bottom basin 508 can be formed from a plurality of basin sections or slabs that include concrete, steel, or a combination thereof.

Bottom basin containment system 500 can include a protective coating 510 applied on a wettable surface of the bottom basin 508. For example, the protective coating can include a caustic-compatible coating or caustic-compatible material that is resistant to a caustic CO₂ capture solution. Protective coating 510 can prevent or reduce degradation of bottom basin 508. Examples of a protective coating 510 can include a stainless steel coating, a polyurethane-based coating system (e.g., Ucrete UD200) which can be trowel-applied, a vinyl ester based composite system (e.g., Ceilcote 242/242MR Flakeline) which can be sprayed or roller-applied, an epoxy based system including fibreglass reinforced material and novolac epoxy topcoat (e.g., Dudick-Protecto-Flex 100XT) which can be trowel-applied, or a combination thereof. In some implementations, the protective coating 510 can include additives that are resistant to degradation from caustic solutions. For example, additives can include PVC particles or fibres.

The bottom basin 508 can include a plurality of concrete slabs or basin sections that are coupled to one another. In some implementations (not illustrated), concrete foundations can include one or more waterstops embedded in concrete slabs or basin sections at construction joints that are located in between slabs or basin sections. Waterstops are embedded in concrete (e.g., concrete slabs or concrete basin sections) and are configured to prevent the passages of fluids, typically liquid, through the joints and into the surrounding environment. Bottom basin 508 is configured to collect CO₂ capture solution 214 that includes a caustic solution, thus bottom basin 508 can benefit from waterstops that are caustic-compatible. Waterstops can include an MOC that is compatible with CO₂ capture solution including caustic solution so that the waterstops are not degraded if CO₂ capture solution 214 leaks between the concrete slabs or concrete basin sections. For example, waterstops embedded in concrete slabs or basin sections at construction joints can be formed from thermoplastic vulcanizate (TPV), PVC, hydrophilic chloroprene rubber, stainless steel, or a combination thereof.

Bottom basin containment system 500 can include a liner 506 (e.g., geomembrane liner). The bottom basin 508 can be at least partially surrounded by a liner 506. Liner 506 can be positioned between the basin and the surrounding ground or grade. In some implementations, at least a portion of liner 506 is in direct contact with bottom basin 508. In some implementations, the liner 506 can act as a tertiary containment in case the protective coating 510 is damaged, and as a result enables the CO₂ capture solution to seep through the bottom basin 508. For example, the liner can be a geomembrane liner 506 that surrounds or underlies at least a portion of the bottom basin 210. The liner 506 can include (e.g., be at least partially formed from) HDPE, ethylene propylene diene monomer (EPDM), or another MOC that is compatible with CO₂ capture solution including caustic solution. In some implementations, liner 506 can have a liner thickness between 0.5 mm to 5 mm thick. For example, liner 506 can be an HDPE liner that has a liner thickness of 1 mm. As illustrated in FIG. 5B, in some cases, a pinch bar 512 can be used to hold the liner 506 against the bottom basin 508. Pinch bar 512 can be a steel bar with a plurality of bolt holes. Pinch bar 512 can pinch liner 506 up against the concrete and be secured with a plurality of bolts. Liner 506 can be terminated against a side of the concrete slab and then sealed with a sealant. The HDPE or comparable material used in the liner 506 provides protection against CO₂ capture solution including caustic solution. In some cases, other types of attachment hardware can be used to secure pinch liner 506 and pinch bar 512 to the bottom basin 508 include: fasteners, clamps, clips, pins, screws, tie-downs, or nails.

Bottom basin containment system 500 can include a non-woven geotextile 504 that surrounds or underlies at least a portion of liner 506. Non-woven geotextile 504 can include a filter fabric that is inserted between liner 506 and crushed gravel 502 (or the surrounding environment) to protect the liner 506 from getting punctured during installation. In some implementations (not illustrated), bottom basin containment system 500 can include a leak detection system that intervenes the bottom basin 508 and the geomembrane liner 506. In one implementation (not illustrated), the geomembrane liner 506 is sandwiched between two protective non-woven geotextile layers.

In some cases, during installation, the liner 506 can be temporarily held in place against the non-woven geotextile with sand before and during a concrete pour (e.g., to form the basin sections or slabs). A monitoring well can be beneficial to reduce backfill between the liner 506 and the bottom basin 508. In some cases, during installation, a concrete basin section or slab can be wrapped with liner 506 before coupling with another basin section or slab.

In some implementations, elements of bottom basin containment system 500 are combinable with any of the elements described in FIG. 1 through FIG. 10. For example, gas-liquid contactor 100a and 100b of FIG. 1, or gas-liquid contactor 200 of FIGS. 2A-2C, can include basin containment system 500 of FIG. 5A through FIG. 5B.

In some cases, foam prevention in the top basin 604 of the gas-liquid contactor 200 can be important. Foam is generally undesired, as it can lead to uneven liquid distribution over the packing 206 and cause challenges with measuring the level of CO₂ capture solution 214 in the top basin 204. Some conventional packing designs can be prone to channeling due to the shape and/or material of the packing and can lower the mass transfer efficiency CO₂ in CO₂-laden gas to the CO₂ capture solution. A gas-liquid contactor can include features configured to mitigate channeling of CO₂ capture solution 214 in the packing.

FIG. 6A and FIG. 6B show a front cross-sectional view and a top view, respectively, of an example liquid distribution system 600a, 600b (collectively 600) including a pressurized distribution pipe with spargers and nozzles for a gas-liquid contactor system according to the present disclosure. Liquid distribution system 600 can achieve a generally even distribution of the CO₂ capture solution 614 into a top basin 604 and reduce splashing or foaming of the CO₂ capture solution 614. Liquid distribution system 600 can include a liquid redistributor 610 (e.g., nozzles 610) that intervenes a first packing section 606a and a second packing section 606b (collectively 606) to redistribute the CO₂ capture solution 614 onto underlying packing sections.

The distribution system 600 can include a distribution pipe with multiple sparger holes 608 along the length of the distribution pipe 602 (e.g., a sparge pipe) to reduce single flow entry splashing issues, which can lead to foam production when air is dispersed in the CO₂ capture solution 614. Distribution pipe 602 (e.g., a sparge pipe) is positioned at least partially above a top basin 604. A set of nozzles 610 can be supported in the top basin 604 to allow fluid flow from top basin 604 onto packing sections 606. Nozzles 610 can be positioned at least partially below the distribution pipe 602. When operating the distribution system 600, a liquid (e.g., CO₂ capture solution 614) flows into the distribution pipe 602, through the sparger holes 608, and into the top basin 604. The top basin 604 collects the CO₂ capture solution 614 and then flows the CO₂ capture solution 614 through the set of nozzles 610 that are at the base of the top basin 604. The nozzles 610 are positioned at least partially over the one or more packing sections 606 and the nozzles 610 to flow the CO₂ capture solution 614 over the one or more packing sections 606. In this design, including sparger holes 608, the nozzles 610 in the top basin 604 can reduce the velocity at which the CO₂ capture solution 614 (e.g., KOH) enters the top basin 604. This can reduce splashing and foaming caused by mixing with gas. In some implementations, sparger holes 608 can be equidistantly positioned to each other. In some implementations, distances between each of the sparger holes 608 can vary. In some implementations, sparger holes can be circular. In some cases, foaming and splashing can be reduced by adjusting the size and/or the number of sparger holes. For example, at a particular flow rate in the distribution pipe 602, larger sparger holes or more sparger holes may reduce the velocity at which liquid flows out of the sparger holes into the top basin, thereby reducing foaming, in comparison to smaller sparger holes or fewer sparger holes.

In some implementations, the nozzles 610 in the top basin can flow the CO₂ capture solution 614 at a range of 0 gpm/ft² to 14 gpm/ft². In some implementations, the CO₂ capture solution 614 can flow through the nozzles 610 in the top basin 604 in a pulse mode, in which the nozzles 610 can flow the solution at a first flow rate for a first time period and then at a second flow rate for a second time period. For example, the nozzles 610 in the top basin 604 can flow the CO₂ capture solution 614 at zero flow for a first time period and then at a flow rate of at less than 14 gpm/ft² for a second time period. For example, the nozzles 610 in the top basin 604 can flow the CO₂ capture solution 614 at a flow rate of at least 4.2 gpm/ft² at a first time period and then at a higher flow rate for a second time period.

In some implementations (not illustrated), sparger holes 608 can be replaced with another set of nozzles (e.g., sparger nozzles) in the distribution pipe 602. In such implementations, the gas-liquid contactor 200 can have two sets of nozzles: a first nozzle set (e.g., sparger nozzles) supported in the distribution pipe 602 to flow CO₂ capture solution 614 into the top basin 604 to reduce splashing and foam production and a second nozzle set supported in the top basin to distribute CO₂ capture solution 614 from the top basin 604 onto the packing sections 606. The two sets of nozzles may differ in design and shape due to the difference in their application in the gas-liquid contactor 200.

In some implementations, a different configuration and additional elements can further reduce splashing and foam production in the top basin. FIG. 6C shows a side cross sectional view of an example liquid distribution system 600 including a weir 616 that divides top basin 604 and sparger holes 608 that are oriented at least partially towards a bottom surface of the top basin 604. As liquid, including CO₂ capture solution, flows through sparger holes 608, weir 616 partially restricts the liquid in the top basin and thereby forms a first reservoir. The liquid level in the first reservoir rises until it trickles or spills over weir 616 to form a second reservoir.

In some cases, the liquid level in the first reservoir can be high enough that sparger holes 608 are at least partially submerged. Nozzles 610 at the bottom of top basin 604 can be fluidly coupled with liquid in the second reservoir. The liquid can flow from the first reservoir into the second reservoir at a velocity that reduces mixing of liquid with surrounding gas. For example, liquid can flow from the first reservoir into a second reservoir in a laminar flow regime. These flow patterns can help reduce frothing within the top basin 604, particularly in the second reservoir where the liquid is fed to nozzles 610.

In some cases, as the CO₂ capture solution 614 flows within a packing section 606, it can start channeling and tend to form rivulets that flow in a single direction, reducing the gas-liquid interfacial surface area. This phenomenon can occur when a fluid being distributed over a surface has a greater flow rate over certain sections of the surface than others. Channeling can reduce the CO₂ capture efficiency of the contactor system.

To address the issue of channeling, liquid distribution system 600 can include one or more liquid redistributors 612 to redirect the CO₂ capture solution 614 for more even distribution in the packing 606. Liquid redistributor 612 can intervene packing sections 606 and can be positioned between the top basin 604 and the bottom basin. In some implementations, liquid redistributor 612 can include a block of splash fill inserted between the layers or sections of packing 606. Liquid redistributor 612 can facilitate random distribution of the CO₂ capture solution 614, thus enabling the CO₂ capture solution 614 to flow in different directions and breaking up any channeling. In some implementations (not illustrated), baffles can be inserted in liquid redistributor 612 (e.g., splash fill) to mitigate bypass of CO₂-laden gas and redirect the CO₂-laden gas to flow through the packing 606, as opposed to around packing 606. Splash fill can include successive layers of horizontal splash bars that continuously break up the liquid into smaller droplets as the liquid falls over the splash bars. Examples of splash fill can include FUTURA, STAR X20 by Babcock &Wilcox SPIG.

In some implementations, liquid redistributor 612 can include a packing section or packing layer that is configured to affect the tendency of the CO₂ capture solution 614 to flow in a particular direction that is different from that of the packing 606. Packing in liquid redistributor 612 is a different configuration than that of the packing 606 to enable a significant change in flow direction and redistribution of the CO₂ capture solution 614. For example, packing 606 can include a packing section comprising a set of packing sheets that are arranged to form a number of flow passages or flutes that are at a first angle, and liquid redistributor 612 can include a packing section comprising a set of packing sheets (e.g., cross-corrugated packing sheets) that are arranged to form a number of flow passages or flutes that are at a second flute angle that is different form the first flute angle. The different flute angle in the liquid redistributor can cause the CO₂ capture solution 614 that has channeled in the packing 606 to flow at a different velocity and in a circuitous or tortuous manner, thus re-distributing the CO₂ capture solution 614. In some implementations, liquid redistributor 612 can be positioned at one or more intersections of the packing 206 (e.g., circulating flow in multiple directions). The flutes can be positioned at one or more flute angles that influence the velocity at which CO₂ capture solution 614 flows. In some cases (not illustrated), liquid redistributor 612 can include a packing section that comprises a continuous packing layer that is integrally formed.

In some implementations, the liquid redistributor 612 can include a packing section positioned at least partially below a first packing section 606a and/or at least partially above second packing section 606b. The packing section of liquid redistributor 612 can have a different flute angle than packing sections 606. For example, the packing section of liquid redistributor 612 can have a lower flute angle than the first packing section 606a. This allows the packing section of liquid redistributor 612 to reduce the CO₂ capture solution 614 flow rate which helps redistribution onto second packing section 606 positioned below.

In some implementations at low flow rates, the nozzles 610 may not have sufficient head to distribute the CO₂ capture solution 614 on packing underneath, so a thin layer of packing with different contact angle or flute angle than the packing underneath can help with the redistribution. For example, liquid redistributor 612 can include a counterflow film packing that is positioned above second packing section 606b (which can include crossflow packing). In such cases, the counterflow film packing can redistribute the CO₂ capture solution onto the second packing section 606b below.

In some cases, there can also be a set of collection troughs and redistribution nozzles positioned between the first section of packing 606a and the counterflow film packing. The CO₂ capture solution can flow from first packing section 606a to the collection troughs and redistribution nozzles which distribute the CO₂ capture solution onto the counterflow film packing. The CO₂ capture solution can then flow through the counterflow film packing and be redistributed onto the second section of packing 606b (e.g., crossflow packing) below.

In some implementations (not illustrated), the liquid redistributor 612 can include a set of redistribution nozzles configured to flow or spray the CO₂ capture solution 614 onto a packing section below. In some implementations (not illustrated), liquid redistributor 612 can include a redistribution basin that can be positioned in between the packing sections 606. The liquid redistributor 612 can include redistribution nozzles, similar to the nozzles 610, that are supported in the redistribution basin. The redistribution basin can divide the packing 206 into a top section and a bottom section. Redistribution nozzles can flow (e.g., spray or distribute) the CO₂ capture solution 614 on the bottom packing section underneath the redistribution basin. The CO₂ capture solution 614 can be pumped into this redistribution basin from the bottom basin or from a holding tank or downstream processing unit (e.g., regeneration, purification, filtration or the like). In some cases, the CO₂ capture solution 614 that is sprayed onto the top packing section from the top basin can be collected in the redistribution basin, and then sprayed using redistribution nozzles onto the bottom packing section underneath the redistribution basin.

In some implementations, elements of liquid distribution system 600 are combinable with any of the elements described in FIG. 1 through FIG. 10. For example, gas-liquid contactor 100a and 100b of FIG. 1, or gas-liquid contactor 200 of FIGS. 2A-2C, can include liquid distribution system 600 of FIG. 6A through FIG. 6C.

FIG. 7 shows a cross-sectional view of example packing supports 709 and baffles 712 for a gas-liquid contactor system according to the present disclosure. In some aspects, a packing 206 of a particular height may require additional support, so that the weight of a first packing section 706a (e.g., top section the packing) along with the liquid hold up in the first packing section 706a does not crush a second packing section 706b (e.g., bottom section of the packing). For example, a gas-liquid contactor can include a first packing section 706a that is positioned at least partially above a second packing section 706b, and a packing support 709 can intervene the packing sections to hold or support the first packing section 706a. In some aspects, at least one packing support 709 can be positioned between the packing sections 706. For instance, a 24 ft. tall packing 709 may comprise two packing sections (each 12 ft. tall), and the packing supports 709 can be positioned between the top and bottom sections of packing.

In some aspects, packing supports 709 can be located (e.g., midway) between top and bottom of the housing 202 of the gas-liquid contactor 200. Packing supports 709 can be coupled to a set of baffles 712. Baffles 712 can include sheets of metal or FRP. In some cases, baffles 712 can mitigate air bypass issues (e.g., bypass of CO₂-laden gas) between the upper and lower sections of packing 706. Baffles 712 can be positioned above and below the packing sections 706 to mitigate air bypass (e.g., bypass of CO₂-laden gas). In some implementations (not illustrated), baffles 712 can be positioned at the sides of the packing 706 to mitigate any air bypass (e.g., bypass of CO₂-laden gas).

In some implementations, packing supports 709 and baffles 712 are combinable with any of the elements described in FIG. 1 through FIG. 10. For example, gas-liquid contactor 100a and 100b of FIG. 1 or gas-liquid contactor 200 of FIG. 2 can include packing supports 709 and baffles 712 of FIG. 7.

FIG. 8 shows a cross-sectional view of example structure that supports structural members 802 and a housing of a gas-liquid contactor according to the present disclosure. In some implementations, the structural members 802 of the gas-liquid contactor 200 can be mounted on a raised wall 804 or structure (or structures) that are part of a bottom basin 808 (e.g., as part of a perimeter or within the basin 808 itself). In some implementations, structural members 802 can be mounted on a combination of the raised wall 804 or structures (such as raised walls 408 in FIG. 4). The raised walls 804 can support the structural members 802 above the liquid level (e.g., liquid including the CO₂ capture solution) in the bottom basin 808. The raised walls 804 can form raised platforms in the plenum 810 and/or bottom basin 808. Raised walls 804 can include (e.g., be at least partially formed from) concrete, stainless steel, an MOC that is compatible with CO₂ capture solution including caustic solution, or combinations thereof. In some cases, raised walls 804 can be coated with a protective coating. For example, the protective coating can include a caustic-compatible coating or caustic-compatible material that is resistant to a caustic CO₂ capture solution. In general, the number (and/or size, and/or material type) of raised walls 804 can increase with the amount of packing and weight of other elements (e.g., fan, motor, housing, structural members) that are included in the gas-liquid contactor system.

Additionally, a gas-liquid contactor can be designed to keep at least a portion of the structural members 802 out of the wettable area or wettable elements within the housing, e.g., any area of the contactor housing in contact with the CO₂ capture solution 214. Examples of wettable elements include the packing and the bottom basin 808.

In some implementations, raised walls 804 are combinable with any of the elements described in FIG. 1 through FIG. 10. For example, gas-liquid contactor 100a and 100b of FIG. 1, or gas-liquid contactor 200 of FIGS. 2A-2C, can include raised walls 804 of FIG. 8.

In some cases, preventing plume re-ingestion can be particularly important to DAC, given the unique properties of a DAC plume (e.g., plume exiting the DAC system tends to be cooler and less buoyant than the warmer plumes exiting the cooling towers). The wind direction may also cause the low-CO₂ air (e.g., the CO₂-lean gas) to be drawn back into the gas-liquid contactor inlet. For example, for some DAC applications the gas-liquid contactor continuously pulls in fresh CO₂-laden gas (e.g., fresh air) for CO₂ capture through the sides (and/or bottom) of the gas-liquid contactor structure, and vents the CO₂-lean gas at the top through a fan stack. In some cases, the plume that is discharged from the gas-liquid contactor can re-enter the inlet. In some cases, multiple gas-liquid contactors can be positioned near or adjacent to one another, and the plume from the outlet of one gas-liquid contactor can enter the inlet of another gas-liquid contactor. Since the mass transfer in the gas-liquid contactor is dependent on CO₂ concentration of the CO₂-laden gas at the inlet, re-ingestion of the plume reduces the CO₂ concentration at the inlet and thus reduces the amount of CO₂ captured in the gas-liquid contactor, thus reducing the overall CO₂ capture efficiency. Therefore, a gas-liquid contactor, such as gas-liquid contactor 100a and 100b of FIG. 1, or gas-liquid contactor 200 of FIGS. 2A-2C, can include one or more design considerations to mitigate this issue, such as fan speed and fan stack height, to avoid plume re-ingestion.

FIG. 9 shows an image of example plume distributions 900 for CO₂-lean gas 906 discharged from different designs of fan 904 and fan stack 902 according to the present disclosure. For example, a fan stack 902 can have different dimensions (height and diameter) compared to conventional cooling tower fan stack designs, so that the CO₂-lean gas 906 disperses substantially upwards and into the ambient environment rather than flowing downwards to the intake of the gas-liquid contactor 200. A taller stack 902 can discharge the CO₂-lean gas 906 at a point that is high enough to substantially circumvent a recirculation zone of the gas-liquid contactor 200. The recirculation zone includes spaces where the CO₂-lean gas is likely to be re-ingested in the intake of the gas-liquid contactor (e.g., near the intake or the open section sides of the housing). CO₂ concentration at the inlet of the gas-liquid contactor may indicate the extent to which CO₂-lean gas is re-ingested. If the CO₂ concentration at the inlet is below the CO₂ concentration of the ambient air or atmospheric air, the gas-liquid contactor may be re-ingesting CO₂-lean gas. The range of inlet CO₂ concentrations that indicate plume re-ingestion may change according to ambient or atmospheric conditions, which in turn, may change over time. For example, with current atmospheric CO₂ concentrations of approximately 410 ppm to 420 ppm, a gas-liquid contactor with some plume re-ingestion can have an inlet CO₂ concentration that ranges from 385 ppm to 420 ppm. An inlet CO₂ concentration that is lower than this range may indicate that the CO₂-lean gas has not sufficiently circumvented the recirculation zone. In some cases, rather than designing the fan 904 and fan stack 902 to push the plume beyond the recirculation zone (such designs can be associated with increased capital or operational expenses), it can be more cost effective to employ one or more additional gas-liquid contactors to help compensate for the reduced CO₂ capture. Such cost optimization considerations are typically a factor in determining a suitable reingestion mitigation strategy. In some aspects, the fan stack 902 can be at least 4 times taller than the standard industry height of a cooling tower fan stack to counter plume re-ingestion. In some implementations, the fan stack 902 height can range from 10 feet to 30 feet. In some implementations, the fan stack 902 height can be sized between 10 feet to 20 feet, or 20 feet to 30 feet.

In some aspects, another approach to reduce plume re-ingestion includes increasing an exhaust velocity of CO₂-lean gas 906 from the fan 904, so that the plume of CO₂-lean gas has an exhaust velocity that is high enough to at least partially circumvent the recirculation zone. In some implementations, the fan 904 and fan stack 902 height can be configured to discharge CO₂-lean gas 906 at an exhaust velocity ranging from 9 m/s to 15 m/s. In some implementations, increased fan velocity can be achieved by reducing the cross-sectional area of the fan stack 902 (e.g., at the outlet of the fan stack 902). For example, the exhaust velocity of the CO₂-lean gas may be doubled by reducing cross-sectional area of the fan stack (e.g., at the outlet) by half. In some implementations, the fan diameter can be sized between 10 feet to 30 feet. In some implementations, the fan diameter can be sized between 10 feet to 15 feet, or 15 feet to 30 feet.

In some cases, aspects of the fan 904 can be configured to increase the exhaust velocity of the CO₂-lean gas 906. The fan 904 may include a larger fan motors to increase fan speed, additional impeller blades, and/or a different design for fan blades pitch in comparison to conventional fan designs.

FIG. 9 shows a computational fluid dynamics (CFD) image of plume distributions 900 of CO₂-lean gas 906 for different heights (3 m, 10 m, 25 m) of the fan stack 902. For each of the fan stack 902 heights, plume distribution (e.g., flow pattern of CO₂-lean gas 906) is shown for a baseline exhaust velocity and twice the baseline exhaust velocity. In cases of low stack height and/or low exhaust velocity, the plume can be somewhat stagnant in the zone on downwind side, (e.g., recirculation zone) and is at risk of being pulled back into the intake of the gas-liquid contactor 200 rather than flowing away from the recirculation zone.

For the example plume distributions 900, fan speed can be held as a constant for each of the flow patterns and the fan stack dimensions are varied to assess velocity. For example, fan stack 902a has a height of 3 meters and diameter of 24 feet. Fan stack 902a discharges CO₂-lean gas 906a at a first exhaust velocity. In comparison, example fan stack 902b has a height of 3 meters and a diameter that is smaller than fan stack 902a, which allows fan stack 902b to discharge CO₂-lean gas 906b a second exhaust velocity that is two times higher than the first exhaust velocity of fan stack 902a.

For example, fan stack 902c has a height of 10 meters and diameter of 24 feet. Fan stack 906c discharges CO₂-lean gas 906c at a third exhaust velocity and at a point that is more distant from the intake than fan stacks 902a and 902b. In comparison, example fan stack 902d has a height of 10 meters and a diameter that is smaller than fan stack 902c, which allows fan stack 902d to discharge CO₂-lean gas 906d at a fourth exhaust velocity that is two times higher than the third exhaust velocity of fan stack 902c.

For example, fan stack 902e has a height of 25 meters and diameter of 24 feet. Fan stack 902e discharges CO₂-lean gas 906e at a fifth exhaust velocity and at a point that is more distant from the intake than fan stacks 902a, 902b, 902c, or 902d. In comparison, example fan stack 902f has a height of 25 meters and a diameter that is smaller than fan stack 902e, which allows fan stack 902f to discharge CO₂-lean gas 906f at a fourth exhaust velocity that is two times higher than the third exhaust velocity of fan stack 902e.

In some implementations, the flow pattern of fan stack 902e reduces re-ingestion more effectively compared to other fan stacks shown in FIG. 9, as it discharges CO₂-lean gas 906 at a higher point and has a smaller cross-sectional area to achieve a higher exhaust velocity.

In some implementations, any of fan 904 or fan stacks 902 902a, 902b, 902c, or 902d are combinable with any of the elements described in FIG. 1 through FIG. 10. For example, gas-liquid contactor 100a and 100b of FIG. 1, or gas-liquid contactor 200 of FIGS. 2A-2C, can include fan 904 or fan stacks 902 902a, 902b, 902c, or 902d of FIG. 9.

FIG. 10 is a schematic diagram of a control system (or controller) 1000 for gas-liquid contactor system, such as gas-liquid contactor 200 shown in FIG. 2. The system 1000 can be used for the operations described in association with any of the computer-implemented methods described previously, for example as or as part of the control system 999 or other controllers described herein.

The system 1000 is intended to include various forms of digital computers, such as laptops, desktops, workstations, personal digital assistants, servers, blade servers, mainframes, and other appropriate computers. The system 1000 can also include mobile devices, such as personal digital assistants, cellular telephones, smartphones, and other similar computing devices. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 1000 includes a processor 1010, a memory 1020, a storage device 1030, and an input/output device 1040. Each of the components 1010, 1020, 1030, and 1040 are interconnected using a system bus 1050. The processor 1010 is capable of processing instructions for execution within the system 1000. The processor may be designed using any of a number of architectures. For example, the processor 1010 may be a CISC (Complex Instruction Set Computers) processor, a RISC (Reduced Instruction Set Computer) processor, or a MISC (Minimal Instruction Set Computer) processor.

In one implementation, the processor 1010 is a single-threaded processor. In some implementations, the processor 1010 is a multi-threaded processor. The processor 1010 is capable of processing instructions stored in the memory 1020 or on the storage device 1030 to display graphical information for a user interface on the input/output device 1040.

The memory 1020 stores information within the system 1000. In one implementation, the memory 1020 is a computer-readable medium. In one implementation, the memory 1020 is a volatile memory unit. In some implementations, the memory 1020 is a non-volatile memory unit.

The storage device 1030 is capable of providing mass storage for the system 1000. In one implementation, the storage device 1030 is a computer-readable medium. In various different implementations, the storage device 1030 may be a floppy disk device, a hard disk device, an optical disk device, or a tape device.

The input/output device 1040 provides input/output operations for the system 1000. In one implementation, the input/output device 1040 includes a keyboard and/or pointing device. In some implementations, the input/output device 1040 includes a display unit for displaying graphical user interfaces.

Certain features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

A number of embodiments of the disclosure have been described. Nevertheless, it will be understood that various modifications may be made without departing from the spirit and scope of the disclosure. Accordingly, other embodiments are within the scope of the following claims. Further modifications and alternative embodiments of various aspects will be apparent to those skilled in the art in view of this description. Accordingly, this description is to be construed as illustrative only. It is to be understood that the forms shown and described herein are to be taken as examples of embodiments. Elements and materials may be substituted for those illustrated and described herein, parts and processes may be reversed, and certain features may be utilized independently, all as would be apparent to one skilled in the art after having the benefit of this description. Changes may be made in the elements described herein without departing from the spirit and scope as described in the following claims.

What is claimed is:

1. A system for capturing CO₂ from a dilute gas source, the system comprising:
a gas-liquid contactor comprising:
a housing coupled to a plurality of structural members;
one or more basins positioned within the housing and configured to hold a CO₂ capture solution, the one or more basins comprising a bottom basin;
one or more packing sections positioned at least partially above the bottom basin;
a fan operable to circulate a CO₂-laden gas through the one or more packing sections; and
a liquid distribution system configured to flow the CO₂ capture solution onto the one or more packing sections, wherein:
the gas-liquid contactor comprises one or more materials of construction (MOCs) that are compatible with the CO₂ capture solution.

2. The system of claim 1, wherein the one or more MOCs comprise at least one of:
stainless steel or fiber reinforced plastic (FRP) comprising vinyl ester and fiberglass.

3. The system of claim 2, wherein the housing comprises one or more openings and one or more cut ends lined with a sealant layer.

4. The system of claim 3 wherein the sealant layer comprises vinyl ester resin.

5. The system of claim 1, further comprising a protective coating applied to at least one of: the plurality of structural members, the housing, or the one or more basins.

6. The system of claim 5, wherein the protective coating comprises at least one of: vinyl ester, polyurethane, stainless steel, or epoxy.

7. The system of claim 1, wherein the bottom basin comprises at least one of: an HDPE basin section or a concrete basin section.

8. The system of claim 7, wherein the concrete basin section embeds a waterstop comprising at least one of: thermoplastic vulcanizate (TPV), PVC, hydrophilic chloroprene rubber, or stainless steel.

9. The system of claim 1, wherein a geomembrane liner surrounds at least a portion of the bottom basin, the geomembrane liner comprising at least one of: HDPE or ethylene propylene diene monomer (EPDM).

10. The system of claim 9, wherein a leak detection system intervenes the bottom basin and the geomembrane liner.

11. The system of claim 1, wherein the plurality of structural members define a plenum comprising a containment that is at least partially segregated from the bottom basin by one or more walls, the bottom basin positioned at least partially below the packing.

12. The system of claim 11, wherein the one or more walls comprise at least one of: concrete or stainless steel.

13. The system of claim 11, wherein the containment comprises a sump fluidly coupled to a drain pipe that is operable to flow a volume of liquid outside of the containment.

14. The system of claim 11 wherein the containment comprises a sump pump positioned within a sump, the sump pump operable to flow a volume of liquid to the bottom basin.

15. The system of claim 11, wherein the plenum comprises a plenum containment floor fitted with a drainage slope of at least 2%.

16. The system of claim 1, wherein the plurality of structural members is mounted above a liquid level in the bottom basin.

17. The system of claim 16, wherein the plurality of structural members is mounted on one or more walls bordering the bottom basin.

18. The system of claim 16, wherein the one or more walls comprises one or more raised walls that extend above the liquid level of the bottom basin.

19. The system of claim 18, further comprising a protective coating applied to at least one of: the one or more walls or the one or more raised walls.

20. The system of claim 1, wherein the liquid distribution system comprises:
one or more liquid distribution pipes each having a set of sparger holes; and
a set of nozzles positioned below the one or more liquid distribution pipes.

21. The system of claim 20, wherein:
the one or more basins comprises a top basin; and
the set of sparger holes is oriented at least partially towards a bottom surface of the top basin.

22. The system of claim 21, further comprising a weir coupled to the bottom surface of the top basin, the weir configured to form a first reservoir and a second reservoir of the CO₂ capture solution in the top basin, wherein the CO₂ capture solution flows from the first reservoir to the second reservoir.

23. The system of claim 22, wherein the set of sparger holes are at least partially submerged in the first reservoir in the top basin.

24. The system of claim 22, wherein the set of nozzles are fluidly coupled with the second reservoir in the top basin.

25. The system of claim 1, wherein the one or more packing sections comprises a first packing section positioned at least partially above a second packing section.

26. The system of claim 25, wherein at least one packing support intervenes the first packing section and the second packing section of the one or more packing sections.

27. The system of claim 25, wherein the first packing section comprises a first flute angle and the second packing section comprises a second flute angle that is different from the first flute angle.

28. The system of claim 25, wherein the one or more packing sections comprises a set of cross-corrugated packing sheets.

29. The system of claim 25, wherein the one or more packing sections comprise substantially no gaps.

30. The system of claim 25, further comprising a liquid redistributor positioned in between the one or more sections of packing.

31. The system of claim 30, wherein the liquid redistributor comprises the second packing section of the one or more packing sections.

32. The system of claim 30, wherein the liquid redistributor comprises one or more redistribution nozzles configured to flow the CO₂ capture solution to the second packing section.

33. The system of claim 1, further comprising a fan stack partially enclosing the fan, wherein the fan stack comprises a fan stack height that is between 10 ft. and 30 ft., between 10 ft. and 20 ft., or between 20 ft. and 30 ft.

34. The system of claim 33, wherein the fan comprises a fan diameter that is between 10 ft. and 30 ft., between 10 ft. and 15 ft., or between 15 ft. and 30 ft.

35. The system of claim 1, wherein the fan is configured to discharge a CO₂-lean gas at an exhaust velocity ranging from 9 m/s to 15 m/s.

36. The system of claim 1, further comprising the set of slatted louvers positioned upstream of the one or more packing sections, the set of slatted louvers oriented to block at least a portion of the CO₂ capture solution.

37. The system of claim 36, wherein the set of slatted louvers is positioned upstream of a set of structured louvers.

38. A method for removing carbon dioxide from a dilute gas mixture, the method comprising:
flowing a CO₂-laden gas into a gas-liquid contactor by operating a fan, the gas-liquid contactor comprising:
a housing comprising a plurality of structural members;
one or more packing sections;
one or more basins; and
a fan stack partially surrounding the fan;
flowing a CO₂ capture solution over the one or more packing sections; and
absorbing at least a portion of CO₂ from the CO₂-laden gas with the CO₂ capture solution to yield a CO₂-lean gas.

39. The method of claim 38, further comprising:
receiving a volume of liquid into a containment, wherein the containment is positioned within a plenum defined by the plurality of structural members and at least a portion of the containment is segregated from the one or more basins.

40. The method of claim 39, wherein at least a portion of the containment is segregated from the one or more basins by one or more raised walls.

41. The method of claim 40, wherein the one or more raised walls comprise at least one of: stainless steel or concrete.

42. The method of claim 40, further comprising raising at least a portion of the plurality of structural members above a liquid level in the one or more basins by supporting the plurality of structural members on the one or more raised walls.

43. The method of claim 39, further comprising draining the volume of liquid from the containment.

44. The method of claim 43, wherein the draining the volume of liquid from the containment comprises:
flowing the volume of liquid into a sump and a drain pipe; and
flowing the volume of liquid outside of the containment.

45. The method of claim 43, wherein draining the volume of liquid from the containment comprises:
flowing the volume of liquid into a sump comprising a sump pump;
operating the sump pump to flow the volume of liquid to the bottom basin.

46. The method of claim 43, wherein draining the volume of liquid from the containment includes flowing the volume of liquid on a plenum containment floor fitted with a drainage slope of at least 2%.

47. The method of claim 38, further comprising flowing the CO₂-laden gas through a set of slatted louvers.

48. The method of claim 47, further comprising flowing the CO₂-laden gas through a set of structured louvers downstream of the set of slatted louvers.

49. The method of claim 38, further comprising:
flowing the CO₂ capture solution into a distribution pipe;
flowing the CO₂ capture solution through a set of sparger holes in the distribution pipe into a top basin of the one or more basins; and
flowing the CO₂ capture solution through a set of nozzles in the top basin to at least a portion of the one or more packing sections.

50. The method of claim 49, wherein the set of sparger holes are oriented at least partially towards a bottom surface of the top basin.

51. The method of claim 50, further comprising flowing the liquid over a weir coupled to the bottom surface of the top basin, the weir forming a first reservoir and a second reservoir in the top basin, wherein the CO₂ capture solution flows from the first reservoir to the second reservoir.

52. The method of claim 51, wherein flowing the CO₂ capture solution through the set of sparger holes includes flowing the CO₂ capture solution through the set of sparger holes submerged in the first reservoir.

53. The method of claim 51, wherein flowing the CO₂ capture solution through the set of nozzles includes flowing the CO₂ capture solution from the second reservoir in the top basin.

54. The method of claim 49, wherein the one or more packing sections comprises a set of cross-corrugated packing sheets.

55. The method of claim 49, further comprising flowing the CO₂ capture solution through a liquid redistributor positioned at least partially below a first packing section of the one or more packing sections.

56. The method of claim 55, wherein flowing the CO₂ capture solution through the liquid redistributor comprises flowing the CO₂ capture solution through a set of collection troughs and a set of redistribution nozzles.

57. The method of claim 56, further comprising flowing the CO₂ capture solution from the set of redistribution nozzles to a counterflow film packing positioned below the redistribution nozzles.

58. The method of claim 55, wherein flowing the CO₂ capture solution through the liquid redistributor comprises flowing the CO₂ capture solution through a counterflow film packing.

59. The method of claim 55, wherein flowing the CO₂ capture solution through the liquid redistributor comprises flowing the CO₂ capture solution through a pressurized distribution pipe and a set of redistribution nozzles.

60. The method of claim 38, further comprising flowing the CO₂ capture solution through a first packing section having a first flute angle and flowing the CO₂ capture solution through a liquid redistributor comprising a second packing section having a second flute angle that is different from the first flute angle.

61. The method of claim 38, wherein operating a fan comprises operating the fan to discharge the CO₂-lean gas from the fan stack at an exhaust velocity of at least 9 m/s to 15 m/s.

62. The method of claim 61 wherein the fan comprises a fan diameter that is between 10 ft. and 30 ft., between 10 ft. and 15 ft., or between 15 ft. and 30 ft.

63. The method of claim 61, wherein the fan stack comprises a fan stack height that is between 10 ft. and 30 ft., between 10 ft. and 20 ft., or between 20 ft. and 30 ft.

64. A system for contacting a gas with a liquid, the system comprising:
a housing coupled to a plurality of structural members;
one or more basins positioned within the housing and configured to hold a liquid, the one or more basins comprising a bottom basin and a top basin;
one or more packing sections positioned at least partially above the bottom basin, the one or more packing sections comprising substantially no gaps;
a fan operable to circulate a gas through the one or more packing sections; and
a liquid distribution system configured to flow the liquid onto the one or more packing sections, the liquid distribution system comprising a set of nozzles and one or more liquid distribution pipes each having a set of sparger holes, wherein the set of nozzles is positioned below the one or more liquid distribution pipes.

65. The system of claim 64, further comprising a weir coupled to a bottom surface of the top basin, the weir configured to form a first reservoir and a second reservoir of the liquid in the top basin, wherein:
the liquid flows from the first reservoir to the second reservoir;
the set of sparger holes are at least partially submerged in the first reservoir; and
the set of nozzles is fluidly coupled with the second reservoir.

66. The system of claim 64, further comprising a liquid redistributor positioned in between the one or more packing sections, wherein the one or more packing sections comprises a first packing section and a second packing section, and the liquid redistributor comprises at least one of: the second packing section or a plurality of redistribution nozzles configured to flow the liquid to the second packing section.

67. The system of claim 64, further comprising a set of baffles positioned adjacent to at least one of: the one or more packing sections or a liquid redistributor.
